(19) United States
(12) Patent Application Publication
(10) Pub. No.: US 2023/0327604 A1
(43) Pub. Date: Oct. 12, 2023

(54) SOLAR MODULE LEADING EDGE SYSTEM AND METHOD

(71) Applicant: SUNFOLDING, INC., Alameda, CA (US)

(72) Inventors: Jonathan Glenn Luedke, Simpsonville, SC (US); Kyle Allen Lamson, San Francisco, CA (US); Peter Aumann, Alameda, CA (US); Jeffrey Charles Lamb, San Francisco, CA (US); Leila Marcia Madrone, Sebastopol, CA (US); Jonah Sternthal, Alameda, CA (US)

(21) Appl. No.: 18/133,855

(22) Filed: Apr. 12, 2023

Related U.S. Application Data
(60) Provisional application No. 63/329,992, filed on Apr. 12, 2022.

(51) Int. Cl. H02S 20/32

(52) U.S. Cl. CPC H02S 20/32

(57) ABSTRACT

A solar tracking system comprising a plurality of solar modules disposed adjacent to each other in a common plane, the plurality of solar modules having respective top and bottom faces and respective opposing first and second edges, the first edges defining a leading edge and the second edges being a trailing edge where the leading edge of the plurality of solar modules is configured to be oriented into a primary air flow such that a primary air flow direction is from the leading edge of the plurality of solar modules to the trailing edge of the plurality of solar modules; and at least one leading edge add-on having an elongated body coupled to and extending from the leading edge of a plurality of the plurality of solar modules, the at least one leading edge add-on having a profile that provides one or more aerodynamic benefits to the plurality of solar modules.

### CROSS-REFERENCE TO RELATED APPLICATIONS

This application is a non-provisional of and claims the benefit of U.S. Provisional Application No. 63/329,992, filed Apr. 12, 2022, entitled “SOLAR MODULE LEADING EDGE SYSTEM AND METHOD,” with attorney docket number 0105935-012PRO. This application is hereby incorporated herein by reference in its entirety and for all purposes.

This application is related to U.S. Non-Provisional Applications filed Apr. 17, 2018, entitled “PNEUMATIC ACTUATOR SYSTEM AND METHOD”, “PNEUMATIC ACTUATION CIRCUIT SYSTEM AND METHOD” and “SOLAR TRACKER CONTROL SYSTEM AND METHOD” having application Ser. Nos. 15/955,044, 15/955,506 and 15/955,519 respectively, and having attorney docket numbers 0105935-003US0, 0105935-004US0 and 0105935-005US0 respectively. These applications are hereby incorporated herein by reference in their entirety and for all purposes.

This application is also related to U.S. Non-Provisional Application filed May 28, 2019, entitled “TUBULAR FLUIDIC ACTUATOR SYSTEM AND METHOD” having application Ser. No. 16/423,899 and having attorney docket number 0105935-006US0. This application is hereby incorporated herein by reference in its entirety and for all purposes.

### BRIEF DESCRIPTION OF THE DRAWINGS

FIGS. 1a and 1b illustrate a respective top perspective and bottom perspective view of a solar tracker in accordance with various embodiments.

FIG. 2 illustrates a side view of a solar tracker during movement.

FIG. 3 illustrates a side view of an actuator in accordance with one embodiment, which comprises an inverted V-shaped bottom plate, a planar top plate, and a set of bladders that are disposed between the top and bottom plates.

FIG. 4a illustrates an example of a solar module aligned with an airflow such that the airflow is coincident with axis Y of the solar module with the airflow initially impacting the first edge of the solar module, flowing over and across the top and bottom faces toward the second edge.

FIG. 4b illustrates an example where a solar module assumes a tilted configuration such as from a neutral configuration N to tilted configuration such that the flow is directed on the top face from the leading edge (LE) to the trailing edge (TE).

FIG. 5 illustrates an example of an airfoil profile in accordance with one embodiment.

FIG. 6 illustrates a side cross-sectional view of the profile of an LE add-on of one embodiment.

FIG. 7 illustrates a side cross-sectional view of the profile of an LE add-on of another embodiment.

FIG. 8 illustrates a side cross-sectional view of the profile of an LE add-on of a further embodiment.

FIG. 9 illustrates a side cross-sectional view of the profile of an LE add-on of yet another embodiment.

FIG. 10 illustrates a side cross-sectional view of the profile of an LE add-on of one embodiment.

FIG. 11 illustrates a side cross-sectional view of the profile of an LE add-on of another embodiment.

FIG. 12 illustrates a side cross-sectional view of the profile of an LE add-on of a further embodiment.

FIG. 13 illustrates an example embodiment of an LE add-on disposed at the first edge of a solar module, where the LE add-on comprises a fluid injection element that is configured to introduce fluid about the surface of the LE add-on.

FIG. 14 illustrates an example embodiment of an LE add-on disposed at the first edge of a solar module, where the LE add-on comprises a fluid extraction element that is configured to extract fluid from about the surface of the LE add-on.

FIG. 15 illustrates an embodiment of an LE add-on that comprises a coupling bracket on an end of the LE add-on that allows the LE add-on to couple with a first edge of a solar module.

FIG. 16a illustrates a perspective top view of a solar tracker that comprises a plurality of solar modules disposed in the same plane and adjacent to each other.

FIG. 16b illustrates a front-side see-through view of the solar tracker of FIG. 16a.

FIG. 17a illustrates a perspective top view of a solar tracker that comprises a plurality of solar modules disposed in the same plane and adjacent to each other.

FIG. 17b illustrates a front-side see-through view of the solar tracker of FIG. 17a.

FIG. 18 illustrates an example embodiment of solar tracker comprising a plurality of solar modules disposed in a row with an LE add-on uniformly disposed along the span of the first edges of the plurality of solar modules.

FIG. 19 illustrates an example embodiment of solar tracker comprising a plurality of solar modules disposed in a row with a plurality of LE add-ons disposed along the span of the first edges of a plurality of the solar modules.

FIG. 20 illustrates an example embodiment of solar tracker comprising a plurality of solar modules disposed in a row with a plurality of LE add-ons disposed along the span of the first edges of the plurality of the solar modules.

FIG. 21 illustrates an embodiment of an LE add-on that comprises a cavity and a coupling bracket on an end of the LE add-on that allows the LE add-on to couple with a first edge of a solar module.

It should be noted that the figures are not drawn to scale and that elements of similar structures or functions are generally represented by like reference numerals for illustrative purposes throughout the figures. It also should be noted that the figures are only intended to facilitate the description of the preferred embodiments. The figures do not illustrate every aspect of the described embodiments and do not limit the scope of the present disclosure.

### DETAILED DESCRIPTION

The cross-sectional shapes of solar modules installed in various industrial solar tracker systems are effectively flat plates with large aspect ratio (chordwise length/thickness). In an aerodynamic sense, these modules can therefore be considered as bluff bodies which can be characterized by a lack of tolerance to misaligned incoming flow angles (incidence angles) resulting in separated shear layers and an oscillating flow pattern called vortex shedding.

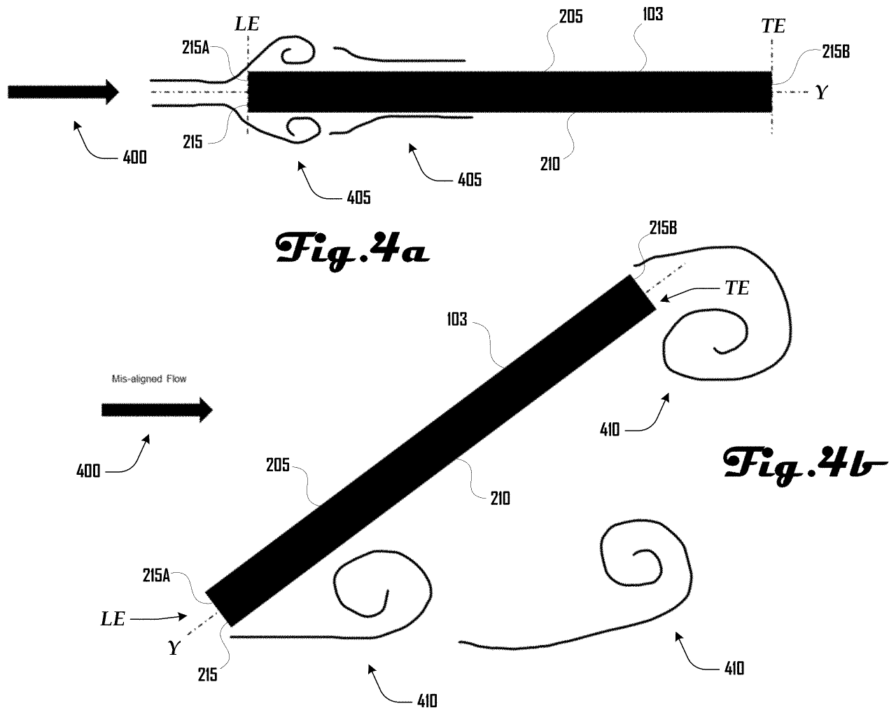

Even with aligned flow, e.g., zero incidence angle, flow separation can be initiated at the sharp corners of the module leading edge (LE) as illustrated in the FIG. 4a. As the incidence angle of the module increases, either due to the tracker purposely rotating to position the module relative to the sun, turbulence in the incoming flow, or through forced motion due to wind loading, the extent of flow separation increases along the length of the module chord and large-scale vortices form on the leeward surface of the module at both the LE and trailing edge (TE) such as shown in the example of FIG. 4b. These low-pressure vortices can alter the overall pressure loading on the module, biasing the loading towards the low-pressure region of the vortices. The vortices can eventually shed from the module surface and travel downstream before reforming, and thus create an oscillatory pressure loading pattern on the module. Significant structural vibrations can ensue in various examples when the oscillation frequency due to vortex shedding aligns with a natural frequency of the solar tracker system structure.

Due to this behavior, vortex shedding can be a significant contributor to the dynamic loading experienced by solar trackers in some embodiments. This dynamic loading can be characterized in various examples by one or both of dynamic buffeting response of downwind trackers interacting with shed vortices from upwind trackers, and self-excited forces caused by the induced motion of the tracker due to vortex shedding.

In view of the foregoing, a need exists for an improved solar module system and method for improving the ability to maintain attached flow in an effort to limit the effects of vortex shedding and overcome the aforementioned obstacles and deficiencies of conventional solar module systems.

Various embodiments discussed herein relate to the shape of one or more edges (e.g., leading edges and/or trailing edges) of a plurality of photovoltaic cells in one or more solar trackers, via shaping of the photovoltaic cells and/or addition of elements to the photovoltaic cells. Examples of solar trackers and solar tracker systems are discussed herein, but these examples should not be construed as being limiting on the wide variety of applications for the embodiments discussed herein, which can include application to various movable or substantially non-movable planar or non-planar structures (e.g., solar reflectors, communication panels, or the like). Additionally, while examples of fluidically actuated bellows or bladder actuators are used herein, further embodiments can include any suitable type of active or passive actuation, including electric motors, or the like.

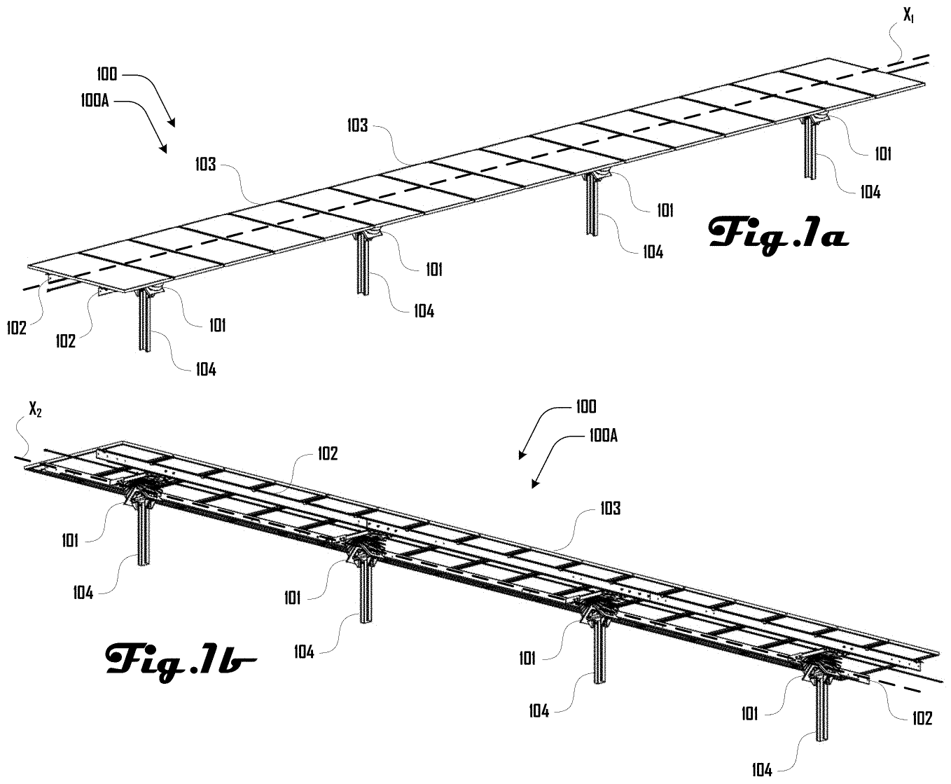

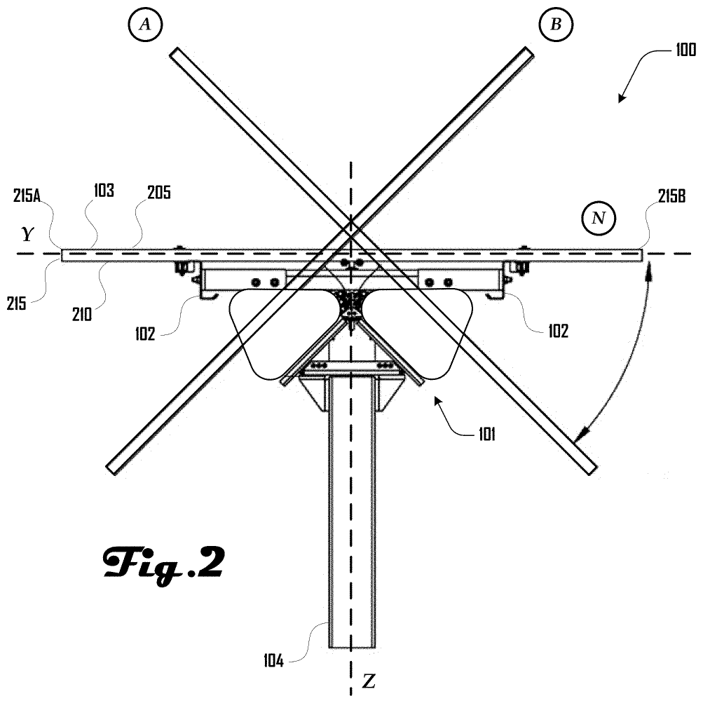

FIGS. 1a and 1b illustrate a respective top perspective and bottom perspective view of a solar tracker 100 in accordance with one embodiment 100A. FIG. 2 illustrates a side view of a solar tracker 100. As shown in FIGS. 1a, 1b and 2, the solar tracker 100 can comprise a plurality of photovoltaic cells 103 disposed along a length having axis X₁ and a plurality of fluidic actuator assemblies 101 configured to collectively move the array of photovoltaic cells 103. As shown in FIG. 1b, the photovoltaic cells 103 are coupled to rails 102 that extend along parallel axis X₂, which is parallel to axis X₁. Each of the plurality of actuators 101 extend between and are coupled to the rails 102, with the actuators 101 being coupled to respective posts 104. As shown in FIG. 2, the posts 104 can extend along an axis Z, which can be perpendicular to axes X₁ and X₂ in various embodiments. In various embodiments, solar cells or photovoltaic cells 103 can be embodied in various ways, including as a solar panels or photovoltaic panels. In various embodiments, the photovoltaic cells 103 can define a top face 205, a bottom face 210 and first and second side edges 215A, 215B.

In various embodiments, the photovoltaic cells 103 can have various suitable sizes such as a width of 30 inches, 35 inches, 36 inches, 37 inches, 38 inches, 39 inches, 40 inches, 41 inches, 41.5 inches, 42 inches, 43 inches, 45 inches, 50 inches, or the like or a range therebetween. In various embodiments, the photovoltaic cells 103 can have various suitable sizes such as a height of 50 inches, 55 inches, 60 inches, 61 inches, 62 inches, 62.6 inches, 63 inches, 64 inches, 65 inches, 66 inches, 67 inches, 68 inches, 69 inches, 70 inches, 71 inches, 72 inches, 73 inches, 74 inches, 75 inches, 76 inches, 77 inches, 78 inches, 79 inches, 80 inches, 81 inches, 82 inches, 83 inches, 84 inches, 85 inches, 90 inches, 95 inches, or the like or a range therebetween. In various embodiments, the photovoltaic cells 103 can have various suitable sizes such as a depth of 50 inches, 55 inches, 60 inches, 61 inches, 62 inches, 62.6 inches, 63 inches, 64 inches, 0.8 inches, 0.9 inches, 1.0 inches, 1.1 inches, 1.2 inches, 1.3 inches, 1.38 inches, 1.4 inches, 1.5 inches, 1.6 inches, 1.7 inches, 1.8 inches, 1.9 inches, 2 inches, 2.5 inches, or the like or a range therebetween.

Further examples of a fluidic actuator 101 are also shown and described in U.S. Non-Provisional Application filed May 28, 2019, entitled “TUBULAR FLUIDIC ACTUATOR SYSTEM AND METHOD” having application Ser. No. 16/423,899 and having attorney docket number 0105935-006US0.

As shown in FIG. 2, and discussed in more detail herein, the actuators 101 can be configured to collectively tilt the array of photovoltaic cells 103 based on an angle or position of the sun, which can be desirable for maximizing light exposure to the photovoltaic cells 103 and thereby maximizing, enhancing or optimizing electrical output of the photovoltaic cells 103. In various embodiments, the actuators 101 can be configured to move the photovoltaic cells 103 among a plurality of configurations as shown in FIG. 2, including a neutral configuration N where the photovoltaic cells 103 are disposed along axis Y that is perpendicular to axis Z. From the neutral configuration N, the actuators 101 can be configured to move the photovoltaic cells 103 to a first maximum tilt position A, to a second maximum tilt position B, or any position therebetween. In various embodiments, the angle between the neutral configuration N and the maximum tilt positions A, B can be any suitable angle, and in some embodiments, can be the same angle. Such movement can be used to position the photovoltaic cells 103 toward the sun, relative to an angle of the sun, to reflect light toward a desired position, or the like.

In one example embodiment as shown in FIGS. 1a and 1b, a solar tracker 100 can comprise a plurality of photovoltaic cells 103 that are collectively actuated by four actuators 101 disposed along a common axis. However, in further embodiments, a solar tracker 100 can comprise any suitable number of actuators 101 including one, two, three, four, five, six, seven, eight, nine, ten, fifteen, twenty, fifty, one hundred, or the like. Similarly, any suitable number of photovoltaic cells 103 can be associated with a solar tracker 100 in further embodiments. Also, any suitable size, shape or type of photovoltaic cells 103 can be associated with a solar tracker 100 in further embodiments. Additionally, while photovoltaic cells 103 are shown in example embodiments herein, in further embodiments, actuators 101 can be used to move various other objects or structures, including mirrors, reflectors, imaging devices, water purification devices, water collection devices, communications devices, and the like.

The actuator assembly 101 can be fixed to a rack, a driven post, a space frame, directly to the ground, or any other suitable substrate. For example, the actuator assembly 101 can be coupled to the ground or other structure via a post 104 as shown in FIGS. 1a, 1b and 2. The actuator assembly 101 can be mounted to this post using bolts, nuts and washers through the flange of the member, or through a web of a bladder unit. An actuator bottom plate can have built-in mounting features, or separate mounting brackets can be used.

The actuator assembly 101 can be attached to a substrate through a mounting bracket. A mounting bracket can comprise a plurality of components. A mounting bracket can allow for positional adjustment in one or many vectors or rotational angles. The mounting bracket can be incorporated into, or act in place of an actuator plate. In some embodiments, the actuator assembly 101 can be mounted directly on the substrate, such as a driven beam. In others, the actuator assembly 101 can utilize the mounting substrate, beam or frame to add strength to the actuator assembly 101.

In another embodiment, the actuator assembly 101 can include a base that comprises a plurality of legs. In a further embodiment, the solar actuator assembly 101 can include a base architecture that holds one or more weights. In one embodiment, the weights can comprise tanks that can be filled with fluid such as water. Such an embodiment can be desirable because the actuator assembly 101 can be lightweight for transport and then secured in place by filling the weights with water or other ballast at a desired location.

The actuator assembly 101 can rotate a payload in various examples, including a payload of photovoltaic cells 103 as shown in FIGS. 1a, 1b and 2. The payload can be attached to the actuator assembly 101 in a variety of ways. In some embodiments, a top plate can be attached to the payload, while a bottom plate remains fixed to a mount. In embodiments with different architecture, the payload can be attached to a center plate, while the frame plate can be fixed to a static mount.

To attach the payload to the actuator assembly 101, the use of spreader brackets or spreader rails can be employed. A spreader bracket rigidly attaches to the rotating plate or component of the actuator assembly 101. The bracket can extend beyond the extreme end of the plate to which it can be attached. The distance of this spread can vary depending on the structural, regulatory or commercially stipulated needs of the payload.

A spreader bracket can be constructed of a metal, such as but not limited to steel, aluminum, a plastic, or a composite such as carbon fiber or fiberglass. A spreader bracket can comprise roll-formed sections, extrusions, castings, composite layup or parts manufactured by any suitable method. A payload can be attached to rails that run perpendicular to and can be attached to spreader brackets.

Some embodiments of the actuator assembly 101 can attach a payload to the actuator via a central tube. The tube can couple the payload and the actuator assembly 101 and can transmit torsional load from the actuator to far down the axis of rotation. The torque tube can incorporate spreader brackets to spread attachment points to payload attachment points.

In some embodiments, one or more actuator assemblies 101 can be coupled together. For example, a pair of single-axis actuator assemblies 101 can be coupled together via one or more photovoltaic cells 103 and/or supports that extend between the actuator assemblies 101. Similarly, another embodiment comprises a plurality of actuator assemblies 101 coupled together via one or more photovoltaic cells 103 and/or supports that extend between the actuator assemblies 101 (e.g., as shown in FIGS. 1a and 1b). In such embodiments, two or more actuator assemblies 101 can move in concert to move a single set of a plurality of photovoltaic cells 103 or solar panels collectively. As shown in various embodiments, such an actuator assembly 101 can be anchored in the ground via posts 104, or the like. Supports can be linked together using bolts and nuts with a connecting bracket, or with a nesting feature between the two lengths of support that can eliminate the need for an additional part. For example, an actuator assembly 101 can be coupled to a post 104 via a bolt assembly.

In one application, the actuator assembly 101 can be used to move and position a photovoltaic cells 103 that is coupled to a top plate. For example, in a first example the actuator assembly 101 can include a post 104 that the actuator assembly rests on. The post 104 can be held by a base or disposed in the ground (e.g., via a ground post, ground screw, or the like) in accordance with some embodiments. This post 104 can be driven into the ground at a variable length depending on loading conditions at the site. The post 104 can be a steel (e.g., alloy steel) component with an I, C, hat, or other cross section. The post 104 can be treated with zinc plating, hot dip galvanizing, or some other method for corrosion resistance.

Although various example embodiments herein describe the use of an actuator assembly 101 with photovoltaic cells 103, in further embodiments, an actuator assembly 101 can be used to actuate or otherwise move any other suitable object, including concentrators, reflectors, refractors, and the like.

An actuator assembly 101 having two bladders or bellows can be configured to move a photovoltaic cells 103 that is coupled to a top plate of the actuator assembly 101 via respective supports 102 that can be mounted perpendicularly to one another and extend along respective lengths of the photovoltaic cells 103. As discussed herein, the bladders or bellows of a one-axis actuator assembly can be configured to inflate and/or deflate to move the solar panel. Supports 102 can be some lightweight steel channel. This channel can have a C, Z, or some other desirable cross section. This channel can be roll-formed, bent, or fabricated in some other manner.

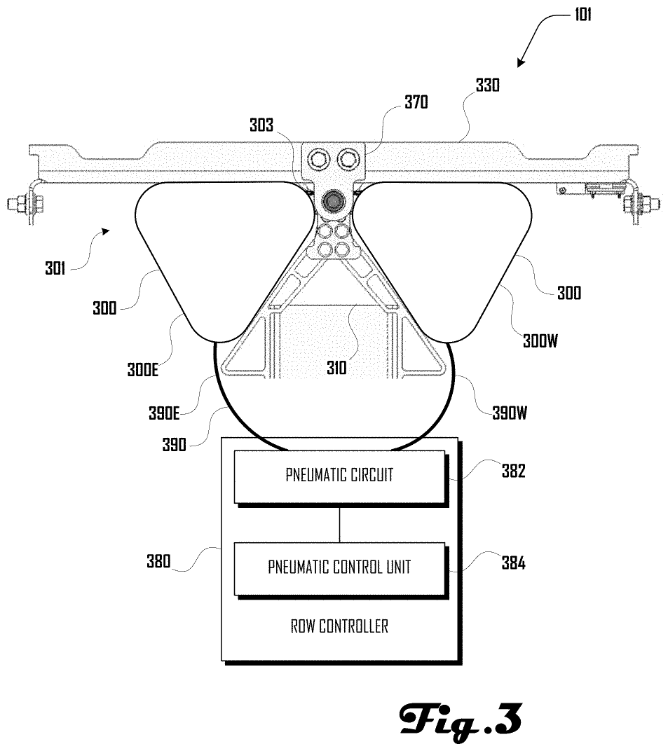

FIG. 3 illustrates a side view of an actuator assembly 101 in accordance with one embodiment. As shown in the example of FIG. 3, the actuator assembly 101 comprises a V-shaped bottom plate 310, a planar top plate 330, and a plurality of bladders 300 of a bladder assembly 301 disposed between the top and bottom plates 330, 310. A hub assembly 370 rotatably couples the bottom and top plates 310, 330 and extends between the bottom and top plates 310, 330. In various embodiments, the bottom plate can be or be referred to as being V-shaped, inverted V-shaped, A-shaped, angled, or the like.

The example embodiment of FIG. 3 illustrates the actuator assembly 101 in a neutral configuration N (see FIG. 2), where the top plate 330 extends along axis Y, which is perpendicular to axis Z in the neutral configuration N. However, as discussed herein, the top plate 330 can be configured to tilt to the left and right (or east and west as discussed herein) based on selective inflation and/or deflation of the bladder 300 of the bladder assembly 301. Components of an actuator assembly 101 can comprise various suitable materials, including metal (e.g., steel, aluminum, iron, titanium, or the like), plastic, composite materials or the like. In various embodiments, metal parts can be coated for corrosion prevention (e.g., hot dip galvanized, pre-galvanized, or the like).

A row controller 380 can be operably coupled with bladder 300 of the actuator via pneumatic lines 390. More specifically, an east bladder 300E can be coupled to a pneumatic circuit 382 of the row controller 380 via an east pneumatic line 390E. A west bladder 300W can be coupled to the pneumatic circuit 382 of the row controller 380 via a west pneumatic line 390W. A pneumatic control unit 384 can be operably coupled to the pneumatic circuit 382, which can control the pneumatic circuit 382 to selectively inflate and/or deflate the bladder 300 to move the top plate 330 of the actuator assembly 101 to tilt photovoltaic cells 103 coupled to the top plate 330.

For example, as described herein, bladder 300 of an actuator assembly 101 can be inflated and/or deflated which can cause the bladder 300 to expand and/or contract along a width of the bladder 300 and cause rotation of the hub assembly 370 and movement of the bottom and top plates 310, 330 relative to each other. Such movement of the hub assembly 370 can be generated when a solar tracker 100 is moving between a neutral position N and the maximum tilt positions A, B as shown in FIG. 2.

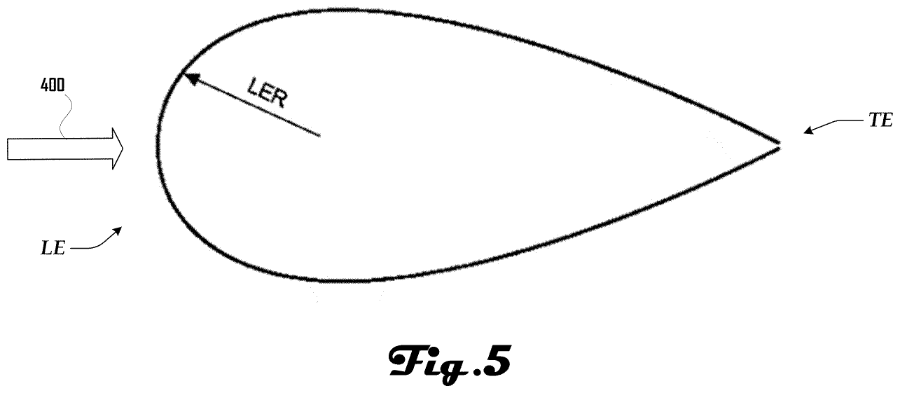

As discussed in more detail herein, a bladder assembly 301 can comprise any suitable plurality of bladders 300, with the bladder 300 being any suitable size and shape. Additionally, as discussed in more detail herein a bladder assembly 301 can comprise one or more bladder units (see, e.g., bladder unit 302 of FIGS. 5a-c) with each of the one or more bladder units comprising any suitable plurality of bladders, including in some embodiments, any suitable number of even numbers of bladder 300. As discussed herein, in some embodiments, a plurality of bladder units that each have two bladders 300 can be stacked to form a bladder assembly 301.

In various embodiments, the bladders 300 can be configured to expand along the width of the bladders 300 when fluid is introduced into the hollow bladders 300 or when the bladders 300 are otherwise inflated. Accordingly, the bladders 300 can be configured to contract along the width of the bladders 300 when fluid is removed from the hollow bladders 300 or when the bladders 300 are otherwise deflated.

Where bladders 300 are configured to expand widthwise based on increased pressure, fluid or inflation and configured to contract widthwise based on decreased pressure, fluid or deflation, movement of the photovoltaic cells 103 via one or more actuators 101 can be achieved in various ways. For example, referring to the example of FIG. 2, rotating the photovoltaic cells 103 west (i.e., to the right in this example) can be achieved via one or more of the following:

TABLE 1
Examples of Actions to Rotate Actuator Assembly 101 West

| East Bladder 300E | West Bladder 300W | Result |
|---|---|---|
| Increase Pressure | Maintain Pressure | Rotate West |
| Increase Pressure | Reduce Pressure | Rotate West |
| Maintain Pressure | Reduce Pressure | Rotate West |
| Decrease Pressure | Decrease Pressure More Than East | Rotate West |
| | Bladder 300E | |
| Increase Pressure | Increase Pressure Less Than East | Rotate West |
| | Bladder 300E | |

Referring again to the example of FIG. 2, rotating the photovoltaic cells 103 east (i.e., to the left in this example) can be achieved via one or more of the following:

TABLE 2
Examples of Actions to Rotate Actuator Assembly 101 East

| East Bladder 300E | West Bladder 300W | Result |
|---|---|---|
| Maintain Pressure | Increase Pressure | Rotate East |
| Reduce Pressure | Increase Pressure | Rotate East |
| Reduce Pressure | Maintain Pressure | Rotate East |
| Decrease Pressure More Than West | Decrease Pressure | Rotate East |
| Bladder 300W | | |
| Increase Pressure Less Than West | Increase Pressure | Rotate East |
| Bladder 300W | | |

Accordingly, in various embodiments, by selectively increasing and/or decreasing the amount of fluid within bladder 300E, 300W, the top plate 330 and photovoltaic cells 103 can be actuated to track the location or angle of the sun.

A tubular actuator assembly 101 can be a fluid driven, antagonistic type actuator. The tubular actuator assembly 101 can be driven by a pressurized working fluid. The working fluid can be gas, such as air, or a liquid, such as water, oil or the like.

The tubular actuator assembly 101 can work on a principle of antagonistic differential forces. For example, in an antagonistic actuator, two force-generating linear sub-actuators (e.g., bladder 300, bladder assembly 301 and/or bladder units 302) can be placed on either side of a pivot. The sub-actuators can generate forces of varying magnitudes. The extension length of the linear sub-actuator can be closely tied to a force it is generating. The sub-actuator can be said to have a “force to position” relationship. The magnitudes of the forces generated and thus the correlated length of the actuator assembly 101 can be dictated by a pneumatic control unit 384. The pneumatic control unit 384 can choose the force values for both sub-actuators. When this is completed the free component or top plate 330 of the actuator assembly 101 can rotate until the torque generated by each actuator (force multiplied by the moment arm) sums to zero. If an external torque is applied to the rotating portion (e.g., top plate 330) of the actuator assembly 101, the actuator assembly 101 can rotate until the sum of the torques, external and internal, is zero.

In some examples of a tubular actuator assembly 101, the sub-actuators can be inflated bladders or bladder 300 as discussed herein. These bladders or bladder 300 can be positioned on opposing sides of a pivot. Depending on the pressure, the pneumatic control unit 384 can inflate to the angle of a free plate (e.g., top plate 330) of the actuator assembly 101, and the bladder 300 can supply a deterministic amount of force. The bladders or bladder 300 can apply this force given the specified angle, at a deterministic distance from the central hub assembly 370. This can create a deterministic moment applied by each bladder 300 given an angle assumed by the rotating top plate 330. All of this can result in a deterministic position given a specific control condition that can set the pressure in either bladder 300. When the pressure in both bladders 300 has been set by the pneumatic control unit 384, the actuator assembly 101 can rotate until the torque (force times the moment arm) generated by both bladders 300 is equal. If an external torque is applied to the top plate 330, the actuator assembly 101 can rotate until the sum of the torques, external and internal, is zero. Given external loading conditions, the actuator assembly 101 can exhibit a deterministic “pressure to position” relationship.

Depending on how the bladders 300 are affixed to the top plate 330 and/or bottom plate 310 in some examples, the center of action can migrate in towards, or out away from a balance point or pivot of the hub assembly 370. As an example, when a bladder 300 is at high pressure, and on the extended side of the hub assembly 370, the contact patch, and thus the center of action of the force applied by the bladder 300, can move closer towards a center pivot of the hub assembly 370. As the top plate 330 rotates and the bladder 300 can go from an extended state to a compressed state, the contact patch can expand and the center of action can move out away from the pivot point of the hub assembly 370. A variety of actuator configurations can be devised to take advantage of this effect.

In various embodiments, the hollow bladder 300 can be configured to be inflated and/or deflated with a fluid (e.g., air, a liquid, or the like), which can cause the bladder 300 to change size, shape and/or configuration. Additionally, the bladder 300 can be deformable such that the bladder 300 can change size, shape and/or configuration.

The bladder 300 can change between a first and second configuration in various suitable ways. For example, the bladder 300 can naturally assume the first configuration when unpressurized or at neutral pressure and then can assume the second configuration via physical compression and/or a negative pressurization of the bladder 300. Additionally, the bladder 300 can naturally assume the second configuration when unpressurized or at neutral pressure and then can assume the first configuration via physical expansion and/or a positive pressurization of the bladder 300.

Additionally, the bladder 300 can be in the second configuration at a first pressurization and expand to the first configuration by pressurization to a second pressure that is greater than the first pressure. Additionally, the bladder 300 can be in the first configuration at a first pressurization and contract to the second configuration by pressurization to a second pressure that is less than the first pressure. In other words, the bladder 300 can be expanded and/or contracted via selective pressurization and/or via physical compression or expansion.

In some embodiments, it can be desirable for the bladder 300 to engage the top and/or bottom plates 330, 310 in a contacting and/or rolling manner in various configurations. In some embodiments, a contact-region of the top and/or bottom plates 330, 310 can provide for a rolling contact between convolutions of a bladder 300, which can be beneficial during movement of the bladder 300 as discussed in more detail herein. Additionally, such a contact-region can be beneficial because it can reduce strain on the bladder 300 during compression and can increase the stiffness of the bladder 300 in certain configurations.

Although certain example embodiments of a bladder 300 are illustrated herein, these example embodiments should not be construed to be limiting on the wide variety of bladder shapes, sizes and geometries that are within the scope and spirit of the present disclosure. For example, in some embodiments, convolutions can have varying size and shape, including varying in a pattern, or the like. Additionally, the bladder 300 can have a curved or rounded contour or can include edges, square portions, or the like.

An actuator assembly 101 can move to assume a plurality of configurations based on the inflation and/or deflation of the bladder 300. For example, the actuator assembly 101 can assume a first configuration A, where a plane TO of the top plate 330 is parallel to a plane BA of the base plate 310. In this first example configuration A, the bladders 300 are of equal length and have a straight central axis CE that is perpendicular to top and bottom planes TO, BA. In such a configuration, the bladder 300 can be at a neutral pressure, partially inflated, or partially deflated. Accordingly, by selectively inflating and/or deflating the bladder 300 of the actuator assembly 101, the plane TO of the top plate 330 can be moved to various desired positions. In some embodiments, single degree of freedom (DOF) actuators can be stacked, to achieve 2 DOF, 3 DOF or any other numbers of DOF.

The architecture of the actuator assembly 101 can take a variety of forms. One example actuator assembly 101 can comprise a top plate 330 rotatably coupled to a bottom plate 310. The bottom plate 310 is then rigidly coupled to a post 104, frame or any other suitable substrate. Inflatable, flexible sub-actuators, bladders, or bladder 300 can be disposed on either side of the coupling. When inflated differentially, the bladder 300 can rotate the top plate 330 to a specific position. This example architecture can be modified in any suitable manner.

In one embodiment, a top plate 330 can be rotatably coupled to a bottom plate 310 in the shape of an inverted V. The bladder 300 can engage with the top plate 330 on the underside of its wings and with legs 311 of the V-plate bottom plate 310. The V-plate can take any suitable angle to achieve the desired range of motion, stiffness or any other behavior or performance. In some embodiments, it can be desirable for the V-plate angle to be 90 degrees. For greater range of motion, the V-plate can have an angle less than 10 degrees. For greater stiffness, the actuator assembly 101 can have a bottom plate angle greater than 120 degrees. In some embodiments, it can be desirable to have a bottom plate angle at the extremes, 180 degrees, flat, where bladder 300 presses on the wings of the plate on either side of the coupling. It can also be desirable in some examples to have a plate with an angle of 0 degrees. In some examples, the bottom plate 310 can more aptly be called a middle plate, in that the bladder 300 can act on either side of the thin plate, rather than on opposing lobes. Likewise, the top plate 330 can take a V-shape and can be configured in any suitable angle. The V-shape in either plate 310, 330 can also be inverted in some examples. An actuator assembly 101 can comprise any combination of top and bottom plates 310, 330.

Another embodiment can comprise an A-frame that is rigidly affixed to a mounting substrate. A center plate can be rotatably coupled to the center of the A-frame. The bladder 300 can mount to engage with either side of the center plate. The bladder 300 can be attached to a coupling point by a web or fascia attached to the bladder 300. The bladder 300 can also be affixed to either the frame or the center plate.

In various embodiments (including example embodiments discussed in more detail herein and in related patent application “PNEUMATIC ACTUATION CIRCUIT SYSTEM AND METHOD”0 having application Ser. No. 15/955,506 and attorney docket number 0105935-004U50), the solar trackers 100 of a solar tracker array can be pneumatically or fluidically coupled via a pneumatic or fluidic system that can actuate the solar trackers 100 of the solar tracker array in unison. In other words, the solar trackers 100 of the solar tracker array can be driven collectively to have the same angle. However, in further embodiments, the actuators 101 can be any suitable type of actuator, such as an electric motor, or the like. Accordingly, the examples discussed herein relating to fluidic actuation should not be construed to be limiting on the wide variety of actuation systems for solar trackers that are within the scope of the present disclosure.

Additionally, some embodiments include solar tracker arrays having solar trackers 100 aligned in linear rows, and further embodiments can have tracker arrays aligned in any suitable way, including an arc, a series of parallel rows, and the like. Additionally, in further embodiments, solar tracker arrays can comprise any suitable number of solar trackers 100. Also, in some embodiments, a plurality of solar tracker arrays can be configured into a solar tracker system. While some embodiments can include a movable solar tracker 100, further embodiments can include any suitable solar assembly, which can be movable, fixed tilt, static, or the like.

Some embodiments can include one or more of a ballasted actuator version with no bottom plate, a torque tube or a custom module mounting. Further embodiments can include an expanded web beam, comprising a web of an I-beam or C-channel that can be slit with three offset rows of slits and can be expanded like expanded metal to form triangular trusses in the web and a higher stiffness beam. In some embodiments, racking configurations can include torque tubes, C-channels, extruded aluminum sections, custom roll formed shapes, hot rolled steel sections, and the like. Still further embodiments can include ballast under the actuator modules to reduce the center of mass height, and such reduced center of mass height can lead to better tracking performance. Other embodiments can include a terrain-following tracker, which can comprise non-moment carrying racking connections to allow the tracker 100 to be installed with variable slope throughout the length of the tracker 100. Some embodiments can include any suitable damper and/or locking system, including a friction brake, pin brake, ratchet, centrifugal clutch, viscous damper, viscoelastic materials, friction damper, linear damper, rotary damper, eddy current damper, pneumatic cylinder, hydraulic cylinder, or the like.

As discussed herein, in various embodiments the cross-sectional shape of one or more solar modules 103 can be a flat plates with a large aspect ratio (chordwise length/thickness) that defines a top face 205, a bottom face 210 and first and second side edges 215A, 215B. In an aerodynamic sense, these solar modules 103 of some embodiments can therefore be considered as bluff bodies which can be characterized by a lack of tolerance to misaligned incoming flow angles (incidence angles) resulting in separated shear layers and an oscillating flow pattern called vortex shedding.

For example, FIG. 4a illustrates an example of a solar module 103 aligned with an airflow 400 (e.g., wind flow) such that the airflow 400 is coincident with axis Y of the solar module with the airflow 400 initially impacting the first edge 215A of the solar module, flowing over and across the top and bottom faces 205, 210 toward the second edge 215B. The face of the first edge 215A in such a context can be defined as the leading edge LE (e.g., the edge 215 where the flow 400 initially contacts the solar module 103) and the second edge 215B can be defined as the trailing edge TE (e.g., the edge 215 where the flow 400 passes after the leading edge LE or the trailing edge that the flow 400 passes over). In various embodiments, even with aligned flow (e.g., zero incidence angle as shown in FIG. 4a), flow separation 405 can be initiated at the sharp corners of the module leading edge LE such as illustrated in the FIG. 4a.

Turning to FIG. 4b, an example is shown where the solar module 103 assumes a tilted configuration such as from a neutral configuration N (see e.g., FIGS. 2 and 4a) to tilted configuration (e.g., at or between tilted configuration B as shown in FIG. 2) such that the flow 400 is directed on the top face 205 from the leading edge LE to the trailing edge TE (e.g., the first and second edges respectively). In various embodiments, as the incidence angle of the solar module 103 increases (e.g., due to the tracker purposely rotating to position the module relative to the sun, turbulence in the incoming flow, or through forced motion due to wind loading), the extent of flow separation can increase along the length of the chord of the solar module 103 and large-scale vortices 410 can form on the leeward surface of the solar module 103 at one or both of the leading edge LE and trailing edge TE (e.g., first and second edges 215A, 215B respectively) such as shown in the example of FIG. 4b.

Such low-pressure vortices 410 can alter the overall pressure loading on the solar module 103, biasing the loading towards the low-pressure region of the vortices 410. The vortices 410 can eventually shed from the module surface and travel downstream before reforming, and thus create an oscillatory pressure loading pattern on the solar module 130, which can be undesirable. Significant structural vibrations can ensue in various examples when the oscillation frequency due to vortex shedding aligns with a natural frequency of a solar tracker 100 or portions thereof.

Due to this behavior, vortex shedding can be a significant contributor to dynamic loading experienced by solar trackers 100 in some embodiments. Such dynamic loading can be characterized in various examples by one or both of dynamic buffeting response of solar downwind trackers 100 interacting with shed vortices from upwind solar trackers 100 (e.g., in embodiments where a plurality of trackers 100 are disposed together in a group, array, or the like), and self-excited forces caused by the induced motion of the tracker 100 due to vortex shedding.

While FIGS. 4a and 4b illustrate an example where the first edge 215A is the leading edge LE and the second edge 215B is the trailing edge TE, it should be clear that in further embodiments, the second edge 215B can be the leading edge LE and the first edge 215B can be the trailing edge TE. Also, while FIGS. 4a and 4b illustrate an example of a flow 400 (e.g., wind or air flow) that is perpendicular to gravity or parallel to neutral configuration N of the solar array 103, it should be clear that flows 400 can be at any suitable direction or angle in further embodiments and that flows 400 can change direction, come from multiple directions, or the like. For example, wind flows can come from the same direction at generally the same angle or wind flows can come from different directions, different angles, multiple angles, or the like.

One approach to configuring or modifying geometry of a solar module 103 to improve the ability to maintain attached flow and limit vortex shedding in some embodiments can be reshaping the module LE with an aerodynamic profile. One such profile can comprise an airfoil as shown in FIG. 5. In the case of an airfoil, it can be in part the rounded profile of the LE that can determine the tolerance to incidence angles and at what incidence angle flow separation and ultimately aerodynamic stall will occur. In various examples, the larger the radius of the LE profile, known as Leading Edge Radius (LER), the greater the ability to maintain attached flow over a larger range of incidence angles. The improved tolerance in various examples can be manifested in stronger boundary layers over a larger extent of the chord of the solar module 103 making the profile less prone to flow separation, increasing the stall angle, and softening the stall event (lower reduction in lift coefficient upon stall).

In various examples, the aerodynamic shaping or configuring of the leading edge LE of a solar module 103 can be accomplished through a device attached to, integrated into, or otherwise combined into the leading edge LE of the solar module 103. In some embodiments, such an element can be referred to as a leading edge LE add-on. In some embodiments, a solar module 103 can be constructed with such a profile as an integral part of the solar module 103. Accordingly, use of the term “add-on” herein should not be construed, for example, to necessarily require such an element to be an after-market element that is added to a solar module 103 or solar tracker 100, although this can be the case in some embodiments.

In some cases, a solar module 103 can have a rounded profile similar to that of an airfoil leading edge LE (e.g., FIG. 5) which can be blended into the leading edge LE of the solar module 103. The result of such a leading edge LE add-on shape can be a contoured leading edge LE surface that can allow flow 400 to travel along the length of the solar module (e.g., over and across the top face 205 and/or bottom face 210) without disruption, and without directly encountering sharp corners of the leading edge LE of the solar module. A leading edge LE add-on shape in various embodiments can allow the boundary layer developed along the surface of the leading edge LE to remain attached to the surface of the leading edge LE and/or top face 205 and/or bottom face 210 at higher incidence angles than possible with the original LE shape of the solar module 103 (e.g., having a flat leading edge LE, sharp rectangular corners, completely flat top and/or bottom faces 205, 210) and therefore alter the flow separation behavior and subsequent vortex shedding from the solar module 103. Depending on the incidence angle, such an LE add-on in some examples may either eliminate all flow separation and therefore completely or substantially suppress vortex shedding from the leading edge LE of the module 103, or otherwise delay the chordwise location of flow separation and reduce the vortical strength of the shedding while also altering its frequency (e.g., compared to a flat LE).

In one example, an airfoil geometry with a thickness equal to the thickness of a solar module 103 is positioned with the airfoil chordline aligned with the module centerline Y and the airfoil max thickness aligned with the plane of the leading edge LE face of the solar module 103. With a symmetric airfoil, this can create a near tangency between the LE add-on and module surfaces 205, 210 and can limit local flow disruption across the intersection.

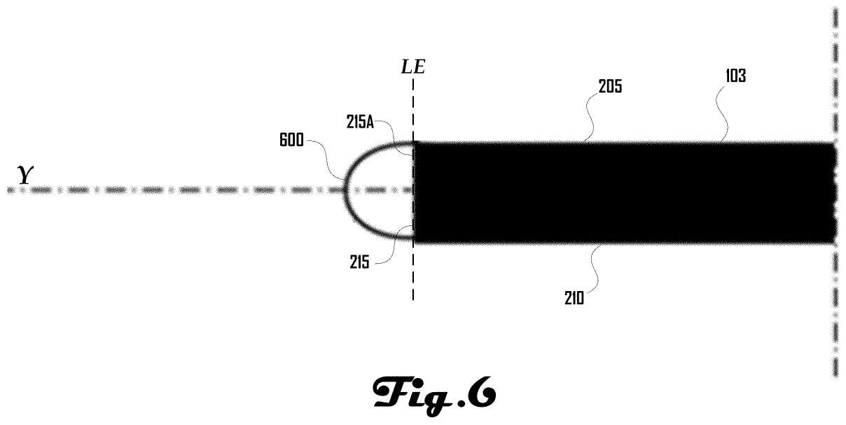

For example, FIG. 6 illustrates a cross-sectional view an embodiment of a solar module 103 where a LE add-on 600 is coupled to the first edge 215A of the solar module 103 on the face of the leading edge LE. The LE add-on 600 can be sized such that the large end of the LE add-on coupled to the leading edge LE is equal to the width of the solar module 103 or in some embodiments just slightly larger or just slightly smaller than the width of the solar module (e.g., ±0.25 mm, 0.5 mm, 0.75 mm, 1.0 mm, 1.25 mm, 1.5 mm, 2.0 mm, or the like). In some embodiments, the LE add-on 600 can be defined by a hemisphere or portion of a circle, oval, ellipse, tear-drop shape, or airfoil with a maximum radius or width of the LE add-on 600 (e.g., aligned with the axis Y of the solar module 130) being equal to, greater than or smaller than the width of the solar module 103 and/or width of the LE add-on 600 at the face of the leading edge LE (e.g., ±1.0 mm, 5.0 mm, 10.0 mm, 20 mm, 50 mm, 100 mm, or the like). In various embodiments, the LE add-on 600 can have a central plane of symmetry that may be coincident with axis Y of the solar module 130 or a central plane of symmetry may be absent.

In various embodiments, the LE add-on 600 can have the same profile along the length of the first edge 215A (e.g., the profile of the cross-section of FIG. 6) or can have a varying profile along the length of the first edge 215A such as tapering from a larger radius at the center to a smaller radius at the edges or the like. Also, while various embodiments discussed herein can relate to an LE add-on, in further embodiments such a features can be manufactured into a portion of a solar module 103 including as an integral part of the solar module 103 in some examples.

In another example, an LE add-on or similar portion of a solar module 103 can be shaped with an airfoil with a thickness greater than the thickness of the solar module 103 in order to create a larger LER, which in various embodiments can provide an improved tolerance to misaligned flow. Such an LE add-on can be aligned such that an airfoil max thickness is positioned at the plane of the module LE face, with a portion of the downstream chord of the airfoil then overlapping the module face. As any covering or shading of the upper and/or lower face 205, 210 may lead to lost energy production in various examples, the airfoil may in another example be shifted forward such that the airfoil intersects the module LE face, for example, at about 80% of the airfoil chord. Some embodiments can be at 60%, 65%, 70%, 75%, 76%, 77%, 78%, 79%, 80%, 81%, 82%, 83%, 84%, 85%, 86%, 87%, 89%, 90%, and the like, of the airfoil chord, or a range between such example values. In various examples, the airfoil shape is then truncated at the face of the module LE. To avoid shading while allowing overlap, some embodiments can include making LE add-on transparent or translucent such that light can pass through the LE add-on and onto the solar module 103 for energy generation.

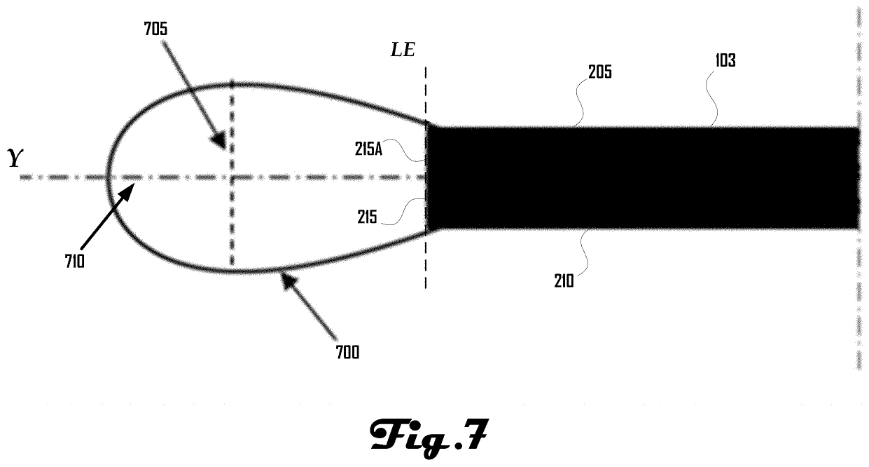

For example, FIG. 7 illustrates one example embodiment of an LE add-on 700 with an airfoil profile having a maximum thickness 705 that is greater than the thickness of the solar module 103 including the thickness of the face of the leading edge LE of solar module 103 at the first end 215A. The airfoil shape of the LE add-on 700 of the example of FIG. 7 has a central plane of symmetry that is coincident with central axis Y of the solar module 103 and the maximum width 710 of the LE add-on 700, with top and bottom faces of the LE add-on 700 having a symmetrical convex curved profile. In this example, the LE add-on 700 tapers from the maximum thickness 705 to a thickness at the first end 215A that is equal to the thickness of the solar module 103 at the first end 215A. Such a taper to the thickness of the first end 215A can end before, at or behind the face of the leading edge LE.

In some embodiments, the maximum width 710 of the LE add-on 700 can be larger than the width of the solar module 103 by 1.0, 1.25, 1.5, 1.75, 2.0, 2.25, 2.5, 2.75, 3.0, 3.25, 3.5, 3.75, 4.0 times, or the like, or a range between such example values. In some embodiments, the maximum thickness 705 of the LE add-on 700 can be larger than the width of the solar module 103 by 1.0, 1.25, 1.5, 1.75, 2.0, 2.25, 2.5, 2.75, 3.0 times, or the like, or a range between such example values. The maximum thickness 705 and maximum width 710 of the LE add-on 700 can be similarly proportioned.

In various embodiments, a taper from the maximum thickness 705 to the first end 215A can be more gradual or have a greater length than a taper from the maximum thickness 705 to a front of the LE add-on 700. In some embodiments, the length from the maximum thickness 705 to the first end 215A can be larger than the length from the maximum thickness to the front end of the LE add-on 700 by 1.0, 1.25, 1.5, 1.75, 2.0, 2.25, 2.5, 2.75, 3.0 times, or the like, or a range between such example values.

In some embodiments, the LE add-on 700 can be defined by a hemisphere or portion of a circle, oval, ellipse, tear-drop shape, or airfoil with maximum radius or width 710 of the LE add-on (e.g., aligned with the axis Y of the solar module 130) being greater than the width of the solar module 103 and/or width of the LE add-on 700 at the face of the leading edge LE as discussed herein. In various embodiments, the LE add-on 700 can have a central plane of symmetry that may be coincident with axis Y of the solar module 130 or a central plane of symmetry may be absent.

In another example, an airfoil with thickness greater than the thickness of the solar module 103 can be positioned with the airfoil max thickness aligned with the module LE face and positioned with the chordline of the airfoil offset below the centerline Y of the solar module 103 such that the upper surface of the airfoil is coincident with the module upper surface 205 at the module LE corner. The LE add-on lower surface can be positioned below the module top and bottom surfaces 205, 210 and can overlap a portion of bottom surface 210 for the length of the airfoil aft of the max thickness of the airfoil. This configuration can provide an enlarged LER relative to the module thickness while maintaining a continuous flow profile on the module upper surface. By offsetting the LE add-ons chordline from the module centerline, this configuration in various examples can also bias the load vector induced on the solar module 103 to encourage rotation of the solar module 103 in a fixed direction and therefore counteract some or any dynamic or mean rotation of the solar module 103. In an alternative configuration, the LE add-on may be positioned with its chordline offset above the module centerline Y, and the lower surface of the airfoil can be positioned coincident with the module lower surface 210 at the module LE corner.

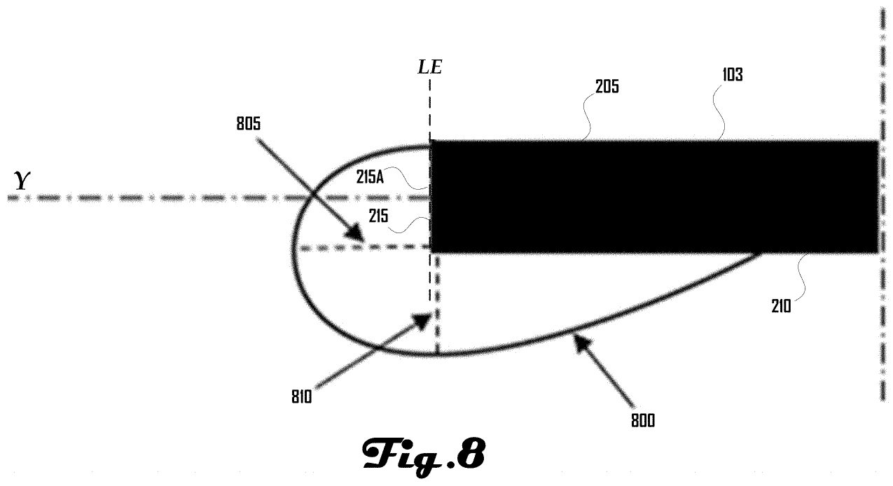

For example, FIG. 8 illustrates an example of an LE add-on 800 coupled to and extending from a front face of a leading edge LE at a first edge 215A of a solar module 103 and from a portion of the bottom face 210 of the solar module 103 proximate to the first edge 215A. As shown in the example of FIG. 8 a portion of the LE add-on 800 can be coupled to the first edge 215A without extending above the plane of the top surface 205 such as to or just below the plane of the top surface 205 (e.g., 0.0 mm, 0.05 mm, 0.1 mm, 0.15 mm, 0.2 mm, 3 mm, 4 mm, or the like or a range between such example values).

The LE add-on 800 can curve outward and downward from the first edge 215A and then back toward the bottom face 210 with the LE add-on 800 being completely convex about the external surface of the LE add-on 800. The LE add-on 800 can comprise a chordline 805 that can be coincident with the plane of the bottom face 210 of the solar module 103 or just above or below the plane of the bottom face 210 (e.g., ±0.0 mm, 0.05 mm, 0.1 mm, 0.15 mm, 0.2 mm, 3 mm, 4 mm, or the like or a range between such example values). Similarly, the LE add-on 800 can comprise a maximum radius, width or distance from the first edge 215A that can be coincident with the plane of the bottom face 210 of the solar module 103 or just above or below the plane of the bottom face 210 (e.g., ±0.0 mm, 0.05 mm, 0.1 mm, 0.15 mm, 0.2 mm, 3 mm, 4 mm, or the like or a range between such example values), which in some examples can be coincident with the chord 805. In some embodiments, such a maximum radius, width or distance from the first edge 215A can be larger than the thickness of the solar module 103 by 1.0, 1.25, 1.5, 1.75, 2.0 times, or the like, or a range between such example values.

The LE add-on 800 can comprise a bottom maximum thickness 810 defined by the maximum thickness of the LE add-on 800 from the bottom face 210 of the solar module 103. The axis of the bottom maximum thickness 810 can be coincident with or just in front or behind the plane of the leading edge LE of the solar module 103 (e.g., ±0.0 mm, 0.05 mm, 0.1 mm, 0.15 mm, 0.2 mm, 3 mm, 4 mm, or the like or a range between such example values). In some embodiments, the bottom maximum thickness 810 can be larger than the thickness of the solar module 103 by 1.0, 1.25, 1.5, 1.75, 2.0 times, or the like, or a range between such example values.

The LE add-on 800 can taper from the maximum thickness 810 to the bottom face 210 of the solar module 103, with the length from the face of the leading edge LE of the first edge 215A and/or the bottom maximum thickness 810 being larger than the thickness of the solar module 103 by 1.0, 1.25, 1.5, 1.75, 2.0, 2.25, 2.5, 2.75, 3.0, 3.25, 3.5, 3.75, 4.0 times, or the like, or a range between such example values. In some embodiments, the LE add-on 800 can be based on a shape of a symmetrical or asymmetrical airfoil (or other suitable shape as discussed herein), but with a portion removed to engage with the solar module 103.

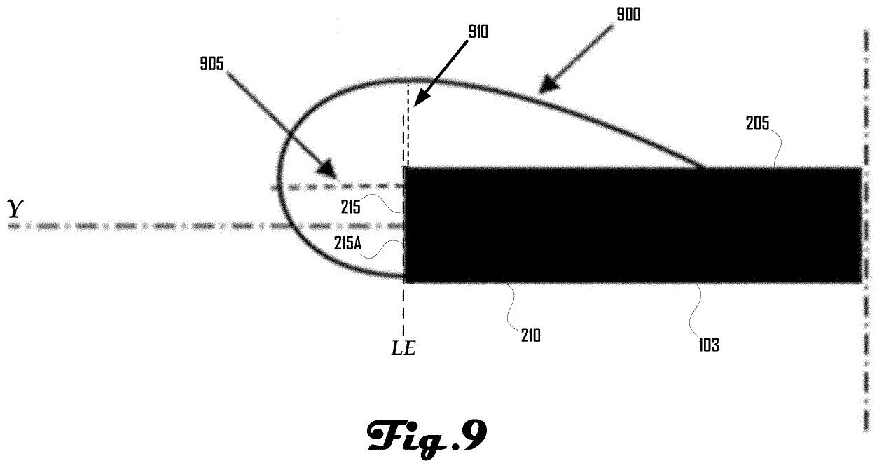

For example, FIG. 9 illustrates an example of an LE add-on 900 coupled to and extending from a front face of a leading edge LE at a first edge 215A of a solar module 103 and from a portion of the top face 205 of the solar module 103 proximate to the first edge 215A. As shown in the example of FIG. 9, a portion of the LE add-on 900 can be coupled to the first edge 215A without extending below the plane of the bottom surface 210 such as to or just below the plane of the bottom surface 210 (e.g., 0.0 mm, 0.05 mm, 0.1 mm, 0.15 mm, 0.2 mm, 3 mm, 4 mm, or the like or a range between such example values).

The LE add-on 900 can curve outward and upward from the first edge 215A and then back toward the top face 205 with the LE add-on 900 being completely convex about the external surface of the LE add-on 900. The LE add-on 900 can comprise a chordline 905 that can be coincident with the plane of the top face 205 of the solar module 103 or just above or below the plane of the top face 205 (e.g., ±0.0 mm, 0.05 mm, 0.1 mm, 0.15 mm, 0.2 mm, 3 mm, 4 mm, or the like or a range between such example values). Similarly, the LE add-on 900 can comprise a maximum radius, width or distance from the first edge 215A that can be coincident with the plane of the top face 205 of the solar module 103 or just above or below the plane of the top face 205 (e.g., ±0.0 mm, 0.05 mm, 0.1 mm, 0.15 mm, 0.2 mm, 3 mm, 4 mm, or the like or a range between such example values), which in some examples can be coincident with the chord 905. In some embodiments, such a maximum radius, width or distance from the first edge 215A can be larger than the thickness of the solar module 103 by 1.0, 1.25, 1.5, 1.75, 2.0 times, or the like, or a range between such example values.

The LE add-on 900 can comprise a top maximum thickness 910 defined by the maximum thickness of the LE add-on 900 from the top face 205 of the solar module 103. The axis of the top maximum thickness 910 can be coincident with or just in front or behind the plane of the leading edge LE of the solar module 103 (e.g., ±0.0 mm, 0.05 mm, 0.1 mm, 0.15 mm, 0.2 mm, 3 mm, 4 mm, or the like or a range between such example values). In some embodiments, the top maximum thickness 910 can be larger than the thickness of the solar module 103 by 1.0, 1.25, 1.5, 1.75, 2.0 times, or the like, or a range between such example values.

The LE add-on 900 can taper from the maximum thickness 910 to the top face 205 of the solar module 103, with the length from the face of the leading edge LE of the first edge 215A and/or the top maximum thickness 910 being larger than the thickness of the solar module 103 by 1.0, 1.25, 1.5, 1.75, 2.0, 2.25, 2.5, 2.75, 3.0, 3.25, 3.5, 3.75, 4.0 times, or the like, or a range between such example values. In some embodiments, a portion of the LE add-on 900 can be transparent or translucent such that light can pass through the LE add-on 900 and contact the top surface 205 of the solar module 103. In some embodiments, the LE add-on 900 can be based on a shape of a symmetrical or asymmetrical airfoil (or other suitable shape as discussed herein), but with a portion removed to engage with the solar module 103.

An LE add-on may be designed in some embodiments with the profile of a cambered airfoil (e.g., in contrast to a symmetric airfoil). This may be done in various examples to alter the force vector the LE add-on creates on the solar module 103 and can bias the resulting moment imparted on the solar module 103 in one direction. The result of this in some examples can be to encourage the solar module 103 to rotate in a preferred direction. Such a cambered airfoil shape may be oriented in either direction, with suction side up or down in accordance with some embodiments. For example, an airfoil shape of some embodiments can have both concave and convex portions as discussed in more detail herein. In some embodiments, such an airfoil can comprise one or more linear portions.

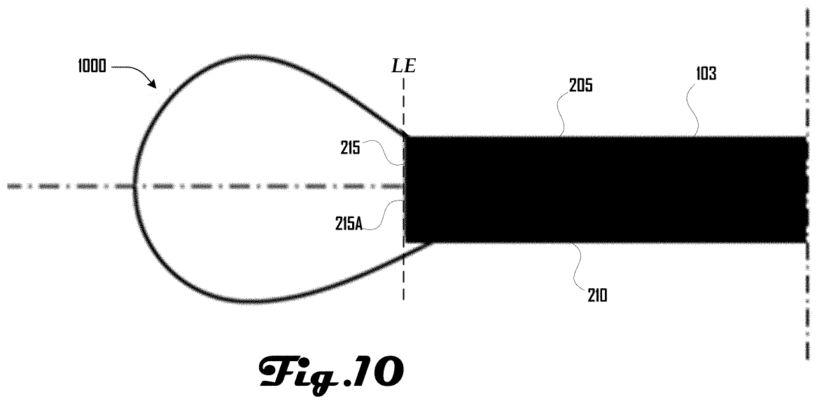

FIG. 10 illustrates an example embodiment of an LE add-on 1000 having an asymmetrical airfoil profile that is coupled to a first end 215A of a solar module 103. As shown in this example, portions of the LE add-on 1000 extend above a plane of the top face 205 of the solar module 103 and below the bottom face 210 of the solar module 103. In some embodiments, portions of the LE add-on 1000 extend a maximum amount above a plane of the top face 205 of the solar module 103 and a maximum amount below the bottom face 210 of the solar module 103 in the same or different amounts, including 1.0, 1.25, 1.5, 1.75, 2.0, times, or the like, or a range between such example values. Additionally, the LE add-on 1000 can extend a maximum length or distance from the plane of the leading edge LE at the first end 215A. In some embodiments, such a maximum length or distance of the LE add-on 1000 can be larger than the width of the solar module 103 by 1.0, 1.25, 1.5, 1.75, 2.0, 2.25, 2.5, 2.75, 3.0, 3.25, 3.5, 3.75, 4.0 times, or the like, or a range between such example values and in some embodiments can be coincident to central axis Y of the solar module 103.

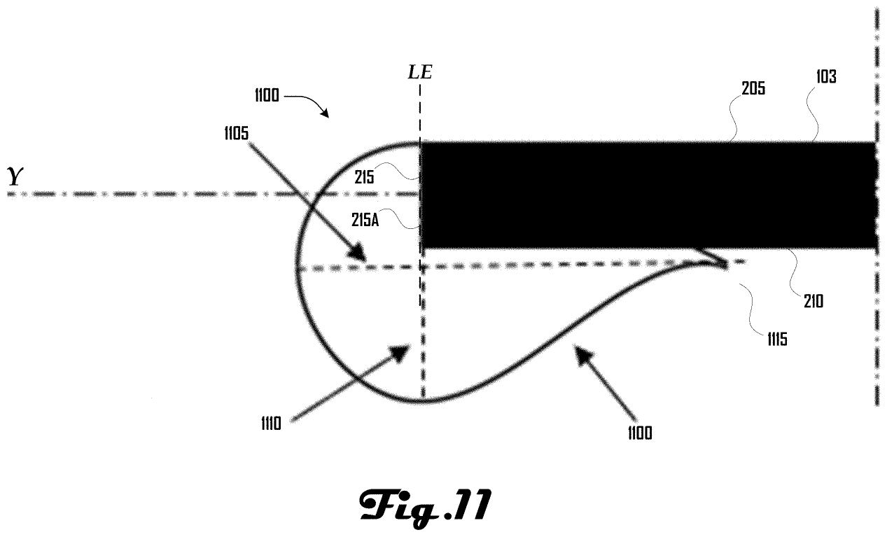

For example, FIG. 11 illustrates an example of an LE add-on 1100 having an asymmetrical airfoil profile coupled to and extending from a front face of a leading edge LE at a first edge 215A of a solar module 103 and from a portion of the bottom face 210 of the solar module 103 proximate to the first edge 215A. As shown in the example of FIG. 11, a portion of the LE add-on 1100 can be coupled to the first edge 215A without extending above the plane of the top surface 205 such as to or just below the plane of the top surface 205 (e.g., 0.0 mm, 0.05 mm, 0.1 mm, 0.15 mm, 0.2 mm, 3 mm, 4 mm, or the like or a range between such example values).

The LE add-on 1100 can curve outward and downward from the first edge 215A and then back toward the bottom face 210 with the LE add-on 1100 being convex about the external surface of the LE add-on 1100 forward of the face of the leading edge LE at the first edge 215A, with the LE add-on 1100 having a concave portion between a maximum thickness 1110 of the LE add-on 1100 and an end 1115 of the LE add-on 1100 disposed at the bottom face 210 of the solar module 103 and inward from the first end 215A toward a center of the solar module 103.

In some embodiments, the end 1115 of the LE add-on 1100 disposed at the bottom face 210 of the solar module 103 can comprise a tail (e.g., where the profile of the LE add-on 1100 comes to a point and defines a tip, which can also define a cavity or lip between the LE add-on 1100 and the bottom face 210 of the solar module 103). In further embodiments, the LE add-on 1100 can taper from the maximum thickness 1110 of the LE add-on 1100 (e.g., with a concave and/or convex portion) to the bottom face 210 of the solar module 103 without the end 1115 forming a tip.

The LE add-on 1100 can comprise a chordline 1105 that can be below the plane of the bottom face 210, and can be coincident with the plane of the bottom face 210 of the solar module 103, or just above or below the plane of the bottom face 210 (e.g., ±0.0 mm, 0.05 mm, 0.1 mm, 0.15 mm, 0.2 mm, 3 mm, 4 mm, 5 mm, 6 mm or the like or a range between such example values). Similarly, the LE add-on 1100 can comprise a maximum radius, width or distance from the first edge 215A that can be coincident with the plane of the bottom face 210 of the solar module 103 or just above or below the plane of the bottom face 210 (e.g., ±0.0 mm, 0.05 mm, 0.1 mm, 0.15 mm, 0.2 mm, 3 mm, 4 mm, 5 mm, 6 mm or the like or a range between such example values), which in some examples can be coincident with the chord 1105. In some embodiments, such a maximum radius, width or distance from the first edge 215A can be larger than the thickness of the solar module 103 by 1.0, 1.25, 1.5, 1.75, 2.0 times, or the like, or a range between such example values.

The LE add-on 1100 can comprise a bottom maximum thickness 1110 defined by the maximum thickness of the LE add-on 1100 from the bottom face 210 of the solar module 103. The axis of the bottom maximum thickness 1110 can be coincident with or just in front of or behind the plane of the leading edge LE of the solar module 103 (e.g., ±0.0 mm, 0.05 mm, 0.1 mm, 0.15 mm, 0.2 mm, 3 mm, 4 mm, or the like or a range between such example values). In some embodiments, the bottom maximum thickness 1110 can be larger than the thickness of the solar module 103 by 1.0, 1.25, 1.5, 1.75, 2.0, 2.25, 2.5, 2.75, 3.0 times, or the like, or a range between such example values.

The LE add-on 1100 can taper from the maximum thickness 1110 to the end 1115 at the bottom face 210 of the solar module, with the length from the face of the leading edge LE of the first edge 215A and/or the bottom maximum thickness 1110 to the end 1115 being larger than the thickness of the solar module 103 by 1.0, 1.25, 1.5, 1.75, 2.0, 2.25, 2.5, 2.75, 3.0, 3.25, 3.5, 3.75, 4.0, 4.25, 4.5, 4.75, 5.0 times, or the like, or a range between such example values. In some embodiments, the LE add-on 1100 can be based on a shape of a symmetrical or asymmetrical airfoil (or other suitable shape as discussed herein), but with a portion removed to engage with the solar module 103.

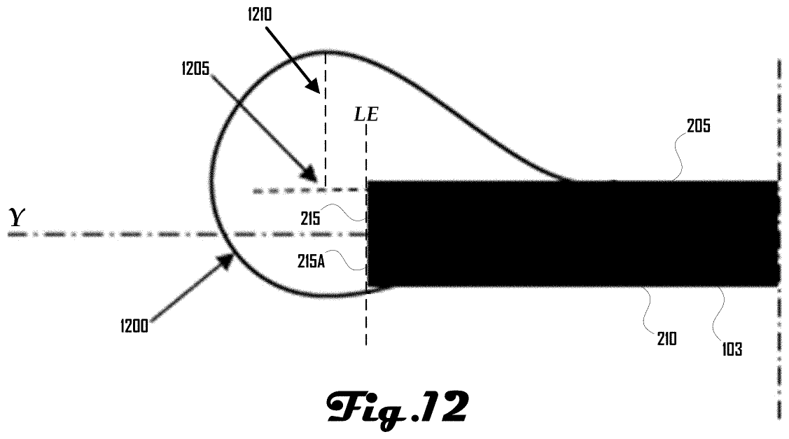

FIG. 12 illustrates an example of an LE add-on 1200 with a asymmetrical airfoil profile coupled to and extending from a front face of a leading edge LE at a first edge 215A of a solar module 103 and from a portion of the top face 205 of the solar module 103 proximate to the first edge 215A. As shown in the example of FIG. 12, a portion of the LE add-on 1200 can be coupled to the first edge 215A without extending below the plane of the bottom surface 210 or just extending past the plane of the bottom surface 210 or just below the plane of the bottom surface 210 (e.g., ±0.0 mm, 0.05 mm, 0.1 mm, 0.15 mm, 0.2 mm, 3 mm, 4 mm, or the like or a range between such example values). In some embodiments, an end of the LE add-on can engage the bottom face 210 of the solar module 103 as shown in FIG. 12 or can end at the first end 215A instead of extending over the bottom face 210 of the solar module 103.

The LE add-on 1200 can curve outward and upward from the first edge 215A and then back toward the top face 205 with the LE add-on 1200 being completely convex about the external surface of the LE add-on 1200 from at least the end at the bottom face 210 of the solar module 103 to a maximum distance 1210 from a plane of the top face 205 and/or chord 1205 of the LE add-on 1200. For example, the LE add-on 1200 can comprise a chordline 1205 that can be coincident with the plane of the top face 205 of the solar module 103 or just above or below the plane of the top face 205 (e.g., ±0.0 mm, 0.05 mm, 0.1 mm, 0.15 mm, 0.2 mm, 3 mm, 4 mm, or the like or a range between such example values).

Similarly, the LE add-on 1200 can comprise a maximum radius, width or distance from the first edge 215A that can be coincident with the plane of the top face 205 of the solar module 103 or just above or below the plane of the top face 205 (e.g., ±0.0 mm, 0.05 mm, 0.1 mm, 0.15 mm, 0.2 mm, 3 mm, 4 mm, or the like or a range between such example values), which in some examples can be coincident with the chord 1205. In some embodiments, such a maximum radius, width or distance from the first edge 215A can be larger than the thickness of the solar module 103 by 1.0, 1.25, 1.5, 1.75, 2.0 times, or the like, or a range between such example values.

The LE add-on 1200 can comprise a top maximum thickness 1210 defined by the maximum thickness of the LE add-on 1200 from the top face 205 of the solar module 103 and/or the chord 1205. The axis of the top maximum thickness 1210 can be coincident with or in front of or behind the plane of the leading edge LE of the solar module 103 (e.g., ±0.0 mm, 0.05 mm, 0.1 mm, 0.15 mm, 0.2 mm, 3 mm, 4 mm, 5 mm, 6 mm, 7 mm, or the like or a range between such example values). In some embodiments, the top maximum thickness 1210 can be larger than the thickness of the solar module 103 by 1.0, 1.25, 1.5, 1.75, 2.0 times, or the like, or a range between such example values.

The LE add-on 1200 can taper from the maximum thickness 1210 to the top face 205 of the solar module, with the length from the face of the leading edge LE of the first edge 215A and/or the top maximum thickness 1210 being larger than the thickness of the solar module 103 by 1.0, 1.25, 1.5, 1.75, 2.0, 2.25, 2.5, 2.75, 3.0, 3.25, 3.5, 3.75, 4.0 times, or the like, or a range between such example values. In some embodiments, the taper from the top maximum thickness 1210 to the top face 205 can comprise convex and/or concave portions. In some embodiments, the taper from the top maximum thickness 1210 can end in a tip (see e.g., FIG. 11) or can taper directly to the top face 205 as shown in FIG. 12. In some embodiments, a portion of the LE add-on 1200 can be transparent or translucent such that light can pass through the LE add-on 1200 and contact the top surface 205 of the solar module 103. In some embodiments, the LE add-on 1200 can be based on a shape of a symmetrical or asymmetrical airfoil (or other suitable shape as discussed herein), but with a portion removed to engage with the solar module 103.

In another example, an LE add-on can comprise or define a pressurized cavity. An LE add-on for example may be constructed as an inflatable body, taking shape when compressed air is fed into it (e.g., having a different inflated and deflated configuration), or as a rigid body with internal volume for storing fluid (e.g., gas and/or liquid). An LE add-on in some examples can serve as a source of stored compressed air to supply another device, such as a pneumatic bladder actuator 101 (see e.g., FIGS. 1-3), a locking mechanism, or the like. The compressed air in various embodiments may be supplied by either an external source (e.g., fluid source of a row controller 380) or can be a sink to receive bleed air from another device within a solar tracker 100 (e.g., a bellows actuator 101) or an overall solar tracker system comprising one or more solar trackers 100.

In some embodiments, an LE add-on or similar structure can be inflated and deflated to change the size, shape or configuration of the LE add-on or similar structure. For example, in one embodiment, an LE add-on can have a flexible inflatable body such that when the LE add-on is inflated, it assumes a shape or configuration of an LE add-on as discussed herein (e.g., LE ad-on 600, 700, 800, 900, 1000, 1100, 1200 and the like). In various embodiments, such an inflatable LE add-on in a deflated state can have a flat configuration (e.g., such that the LE add-on gives a solar module 103 a flat profile such as shown in FIGS. 2, 4a, 4b, or the like), or such that the LE add-on has a flatter, smaller, contracted, less-rigid, floppy and/or deflated profile or configuration compared to the inflated configuration.

In some embodiments, inflation and deflation of an LE add-on can cause the LE add-on to change shape or configuration. For example, in one embodiment, a partially or fully deflated LE add-on can have a shape such as the LE add-on 600 of FIG. 6, and when fully or partially inflated, the LE add-on can change to have a shape such as the LE add-on 700 of FIG. 7, the LE add-on 1000 of FIG. 10, or the like.

In another embodiment, a partially or fully deflated LE add-on can have a shape such as the LE add-on 800 of FIG. 8, and when fully or partially inflated, the LE add-on can change to have a shape such as the LE add-on 1100 of FIG. 11, or vice versa. In a further embodiment, a partially or fully deflated LE add-on can have a shape such as the LE add-on 900 of FIG. 9, and when fully or partially inflated, the LE add-on can change to have a shape such as the LE add-on 1200 of FIG. 12, or vice versa. In another embodiment, a partially or fully deflated LE add-on can have a symmetrical shape, and when fully or partially inflated, the LE add-on can change to have an asymmetrical shape, or vice versa. In yet another embodiment, a partially or fully deflated LE add-on can have a profile that comprises concave portions, and when fully or partially inflated, the LE add-on can change to have a profile without concave portions, or vice versa.

In various embodiments, the shape, size and position of an LE add-on may be optimized in order to achieve a desired outcome relative to range of incidence angle tolerance and orientation of resultant load vector.

The ability of an LE add-on to provide incidence angle tolerance may be enhanced in some embodiments by incorporating flow control elements on the LE add-on surface or other suitable location. The use of high-momentum fluid injection along the surface to energize the boundary layer or fluid extraction on the surface to remove the low-momentum boundary layer in various examples can be used to delay flow separation along an adverse pressure gradient such as that along the profiled surface of the LE add-on.

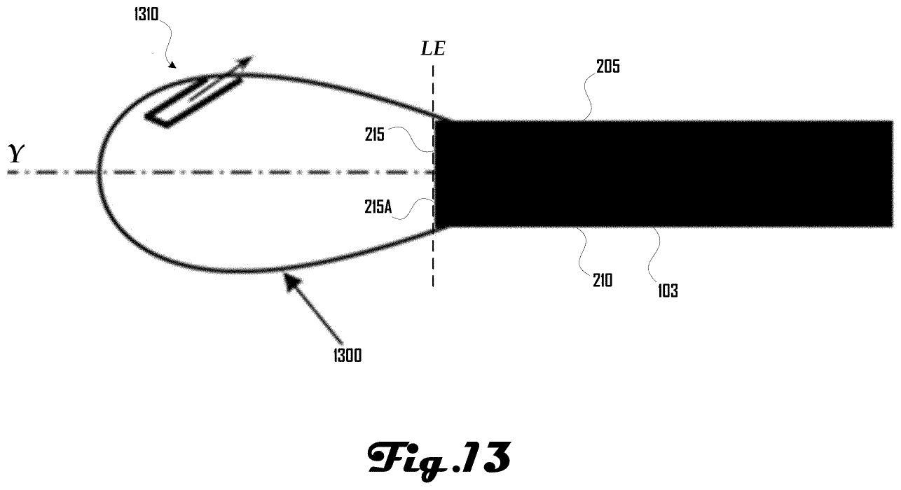

For example, FIG. 13 illustrates an example embodiment of an LE add-on 1300 disposed at the first edge 215A of a solar module 103, where the LE add-on 1300 comprises a fluid injection element 1310 that is configured to introduce fluid (e.g., air) about the surface of the LE add-on 1300. In some embodiments, fluid can be injected about the surface of an LE add-on perpendicular to the tangent of the surface at a given location or at a suitable angle relative to the perpendicular to the tangent such as ±5°, 10°, 15°, 20°, 25°, 30°, 35°, 40°, 45°, 50°, 55°, 60°, 65°, 70°, 75°, 80°, 85°, or the like, or a range between such example values. Some embodiments can comprise a single fluid injection element 1310 or any suitable plurality of fluid injection elements 1310 located at any suitable location(s) on the surface of an LE add-on or other suitable location. In some embodiments, fluid injected by one or more fluid injection elements 1310 can originate from a fluid cavity within the LE add-on or other suitable fluid source.

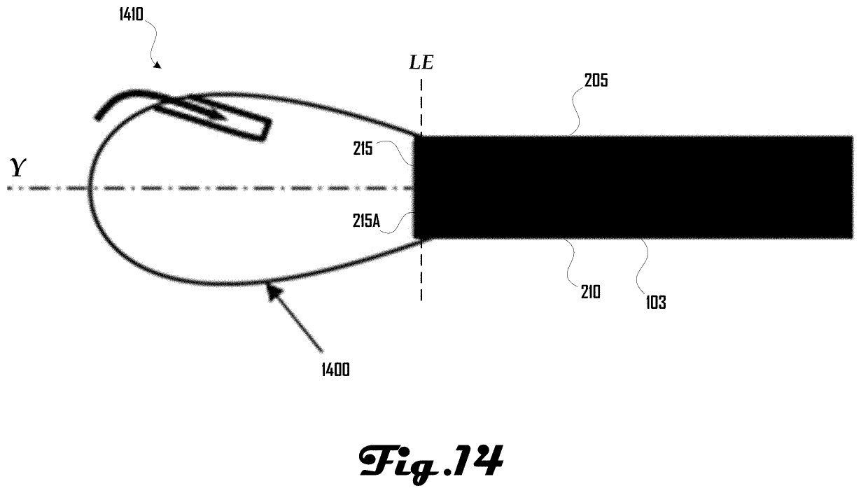

In another example, FIG. 14 illustrates an example embodiment of an LE add-on 1400 disposed at the first edge 215A of a solar module 103, where the LE add-on 1400 comprises a fluid extraction element 1410 that is configured to extract fluid (e.g., air) from about the surface of the LE add-on 1400. In some embodiments, fluid can be removed from the surface of an LE add-on perpendicular to the tangent of the surface at a given location or at a suitable angle relative to the perpendicular to the tangent such as ±5°, 10°, 15°, 20°, 25°, 30°, 35°, 40°, 45°, 50°, 55°, 60°, 65°, 70°, 75°, 80°, 85°, or the like, or a range between such example values. Some embodiments can comprise a single fluid extraction element 1410 or any suitable plurality of fluid extraction elements 1410 located at any suitable location(s) on the surface of an LE add-on or other suitable location. In some embodiments, fluid extracted by one or more fluid extraction elements 1410 can be directed to a fluid cavity within the LE add-on or to another suitable fluid storage location or to an exit port. In some embodiments, the fluid extraction element 1410 can extract fluid from about the surface of the LE add-on passively or actively via suction, or the like.

An LE add-on of various embodiments can be designed with an articulating feature that is used to adjust the shape of the add-on and/or align the chordwise axis of the profile with the oncoming wind. Such articulation may be accomplished in various suitable ways including via a mechanical rotation from a motor driven device or by a deflection driven by a fluidic system, with some examples including one or more pressure regions to enable a more detailed shape change. The LE add-on in some examples may be constructed of a shape memory alloy to achieve this articulation.

An LE add-on in various embodiments may have a reflective outer surface in order to enhance solar radiation onto one or more solar module 103 in the proximity of the LE add-on or that the LE add-on is coupled to. In some examples, such an element may be constructed from a material having a reflective surface or be coated with a reflective material.

The LE add-on may attach to the frame or other suitable element of a solar module 103 in various suitable ways. One example method of attachment can include a fixture such as a bracket integrated into the back end of the LE add-on that slides over top of a frame of a solar module 103 and can be secured to the solar module 103 in some examples via a tightening feature such as clamp or other suitable mechanical fastener.

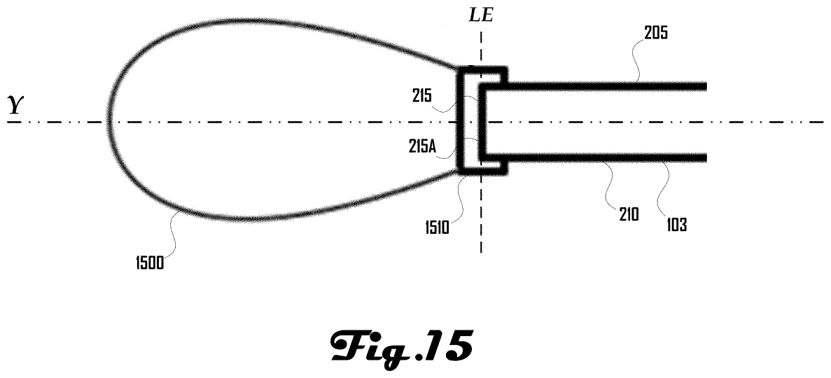

For example, FIG. 15 illustrates an embodiment of an LE add-on 1500 that comprises a coupling bracket 1510 on an end of the LE add-on 1500 that allows the LE add-on to couple with a first edge 215A of a solar module 103. The coupling bracket 1510 can comprise a web with a pair of arms extending from the web that defines a coupling cavity. The bracket 1510 can be disposed on the first edge 215A of the solar module 103 with the first edge 215A disposed within the coupling cavity with the face of the leading edge LE contacting the web with the pair of arms extending respectively over the top and bottom faces 205, 210 of the solar module 103. In some embodiments, a friction fit between the bracket 1510 and first edge 215A can allow the LE add-on to be coupled to the solar module 103. In further embodiments, an adhesive, welding, fixing element (e.g., screw or bolt) or other suitable method can be used to couple the bracket 1510 to the solar module 103.

In some embodiments, an LE add-on may be designed to provide structural stiffness and/or strength to a solar tracker 100. A solar tracker 100 of some embodiments may be designed with the LE add-on serving as a purlin to provide spanwise stiffness. The LE add-on can be designed in some examples such that it spans the length of multiple solar modules 103 and secures the front edges 215 of the solar modules 103 to one another, creating spanwise stiffness along the front edge 215 of multiple solar modules 103.

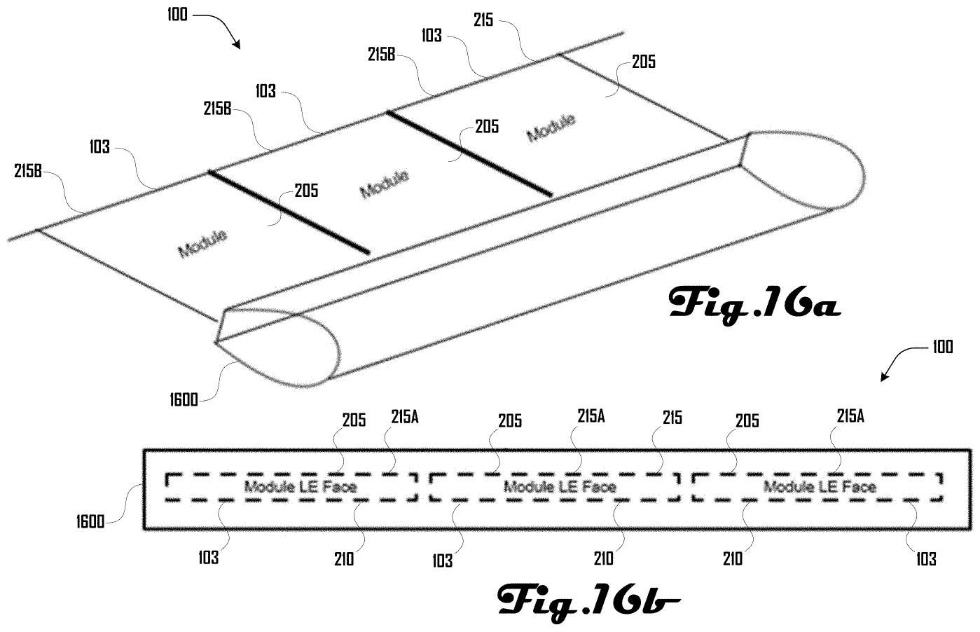

For example, FIG. 16a illustrates a perspective top view of a solar tracker 100 that comprises a plurality of solar modules 103 disposed in the same plane and adjacent to each other, and FIG. 16b illustrates a front-side see-through view of the solar tracker 100. As shown in the example of FIGS. 16a and 16b, the solar tracker 100 can comprise an LE add-on 1600 coupled to the first edges 215A of the solar modules 103. The LE add-on 1600 can span the plurality of solar modules 103 and can be configured to couple or otherwise provide structural support to the plurality of solar modules 103. In some embodiments, the LE add-on 1600 can be configured to provide primary structural support to the first edges 215A of the solar modules 103, with other structural supports such as rails, purlins, or the like, being absent at the first edges 215A, but being present at the second edges 215B. While the examples of FIGS. 16a and 16b illustrate an example where the LE add-on 1600 spans at least three solar modules 103, further embodiments can include an LE add-on that spans any suitable plurality of solar modules 130, including 2, 3, 4, 5, 6, 7, 8, 9, 10, 15, 20, 25, 30, 50, 100, or the like, or a range between such example values.

In some examples, rather than spanning multiple solar modules 103, an LE add-on of some embodiments can accomplish such stiffening by spanning a single solar module 103 and having one or more interlocking features on the span ends of the LE add-ons that connect to those of an adjacent solar module 103 and/or LE add-on assembly, effectively securing the solar modules 103 to each other.

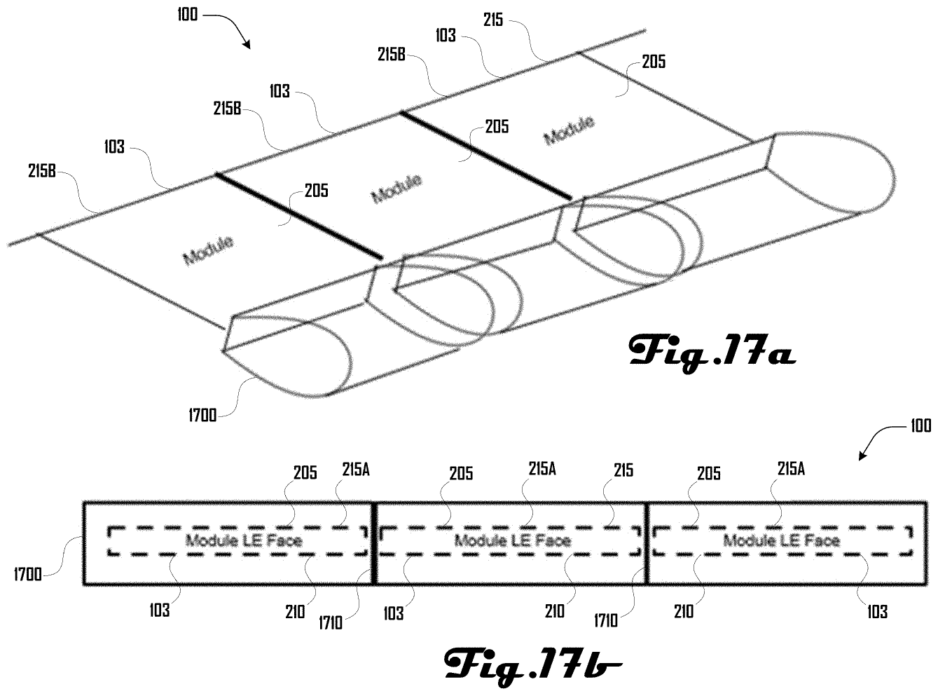

For example, FIG. 17a illustrates a perspective top view of a solar tracker 100 that comprises a plurality of solar modules 103 disposed in the same plane and adjacent to each other, and FIG. 17b illustrates a front-side see-through view of the solar tracker 100. As shown in the example of FIGS. 17a and 17b, the solar tracker 100 can comprise a set of LE add-ons 1700 that are respectively coupled to the first edges 215A of the solar modules 103. In various embodiments, one or both sides of the LE add-ons 1700 can include couplers 1710 that allows adjacent LE add-ons 1700 to be joined together via the coupler(s) 1710. Such couplers can include various suitable elements or features such as a complementary flange and slot, a weld, an adhesive, a magnet, a bolt, or the like.

The set of coupled LE add-ons 1700 can span the plurality of solar modules 103 and can be configured to couple or otherwise provide structural support to the plurality of solar modules 103. In some embodiments, the set of coupled LE add-ons 1700 can be configured to provide primary structural support to the first edges 215A of the solar modules 103, with other structural supports such as rails, purlins, or the like, being absent at the first edges 215A, but being present at the second edges 215B.

While the examples of FIGS. 17a and 17b illustrate an example where the coupled LE add-ons 1700 span at least three solar modules 103, further embodiments can include a set of LE add-ons 1700 that span any suitable plurality of solar modules 130, including 2, 3, 4, 5, 6, 7, 8, 9, 10, 15, 20, 25, 30, 50, 100, or the like, or a range between such example values. Also, while the examples of FIGS. 17a and 17b illustrate an example where only a single LE add-on 1700 is coupled to each respective solar module 103, in further embodiments, any suitable plurality of LE add-ons 1700 (e.g., 2, 3, 4, 5, 10, 20, or the like) can be associated with a given solar module 103 and coupled together to generate a unitary body. Also, in some embodiments, a given LE add-on 1700 of a set of a plurality of coupled LE add-ons 1700 can span a plurality of solar modules 103 in whole or in part, with each LE add-on 1700 spanning 1.25, 1.5, 1.75, 2, 2.25, 2.5, 2.75, 3, 4, 5, 6, 10, 20 or other plurality of solar modules 103 in whole or in part, or a range between such example values. Also, while the examples of FIGS. 17a and 17b illustrate an example where couplers 1710 are disposed at or between where adjacent solar modules 103 meet, in further embodiments, some or all of such couplers 1710 can couple the set of 1700 along the length of the first edge 215A such as in the middle of the length of the first edge 215A or other suitable location.

In some embodiments, an LE add-on may be integrated into the frame of the solar module 103 itself as opposed to being an add-on device or element. Such an integrated LE add-on in some examples can have interlocking features included at the span ends to connect two adjacent solar modules 103 together. Such an interlocking feature in various examples can aid in properly aligning solar modules 103 relative to each other. Likewise, an LE add-on in some examples may serve as a solar module 103 alignment tool by providing alignment references at the spanwise edge of each solar module 103. The LE add-on of various embodiments can enable the installation of multiple solar modules 103 at one time by pre-assembling the solar modules 103 together using the LE add-on to connect each solar module 103 to its adjacent solar modules 103.

In some examples, LE add-ons may be uniformly oriented along the span of a tracker row defined by a plurality of solar modules 103. In some examples, LE add-ons can be arranged non-uniformly with a variety of potential distributions including one or more of the following examples: Intermittent distribution with LE add-ons only located at specific spanwise locations in order to provide a spanwise distributed forcing to counteract predominant mode shapes (e.g., centered between modal nodes); Spanwise variation of LE add-on size to create a spanwise variation in characteristic shedding frequencies (e.g., to avoid coherency); LE add-ons implemented with different lengths through a solar tracker array to create row by row variation in characteristic shedding frequencies; and the like.

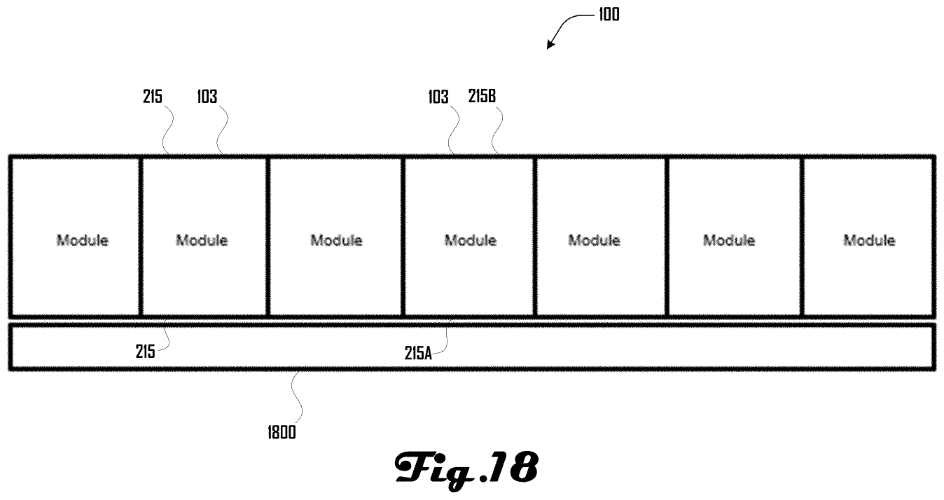

For example, FIG. 18 illustrates an example embodiment of solar tracker 100 comprising a plurality of solar modules 103 disposed in a row with an LE add-on 1800 uniformly disposed along the span of the first edges 215A of the plurality of solar modules 103.

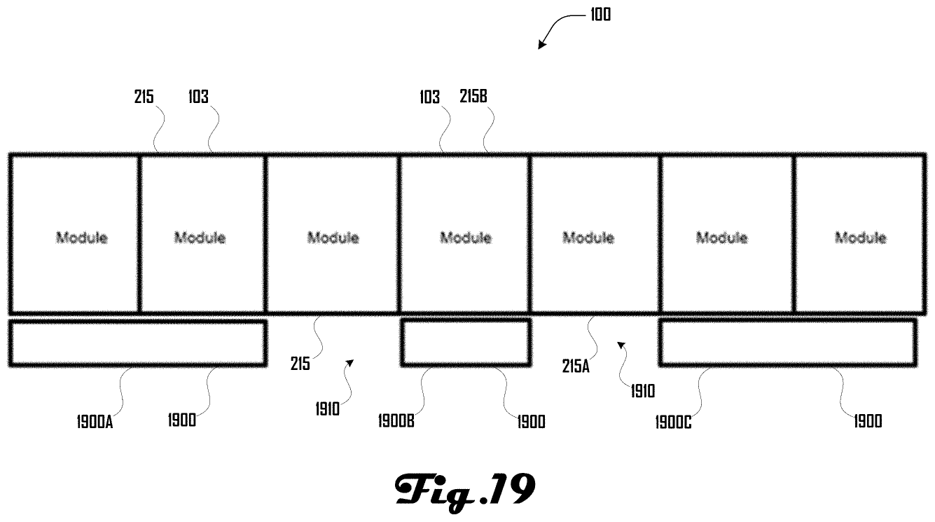

In another example, FIG. 19 illustrates an example embodiment of solar tracker 100 comprising a plurality of solar modules 103 disposed in a row with a plurality of LE add-ons 1900 disposed along the span of the first edges 215A of a plurality of the solar modules 103. In this example, a first LE add-on 1900A is disposed along the span of the first edges 215A of two solar modules 103, a second LE add-on 1900B is disposed along the span of the first edge 215A of a single solar module 103, and a third LE add-on 1900C is disposed along the span of the first edges 215A of two solar modules 103. Additionally, in this example, two solar modules 103 are lacking an LE add-on 1900 such that a gap 1910 is generated between respective LE add-ons 1900. In such an example, some or all of the first, second and third LE add-ons 1900A, 1900B, 1900C can have the same profile or can have different profiles.

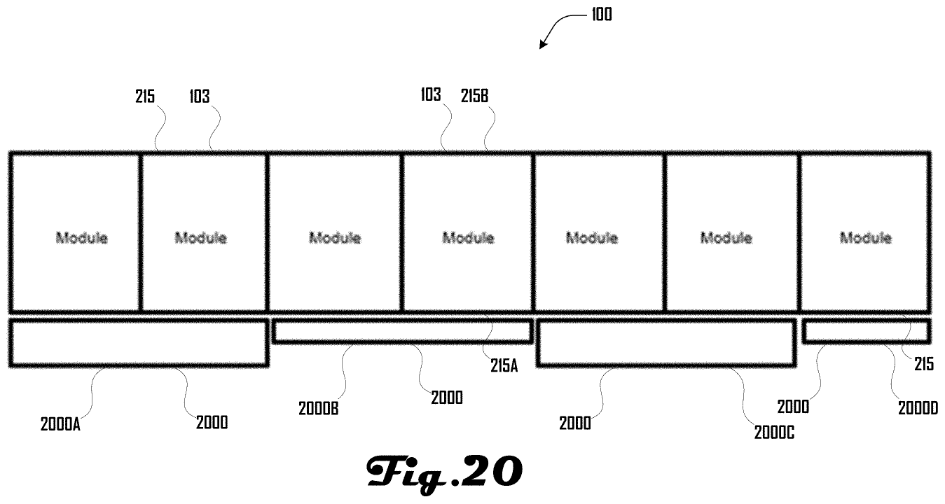

In another example, FIG. 20 illustrates an example embodiment of solar tracker 100 comprising a plurality of solar modules 103 disposed in a row with a plurality of LE add-ons 2000 disposed along the span of the first edges 215A of the plurality of the solar modules 103. In this example, a first LE add-on 2000A is disposed along the span of the first edges 215A of two solar modules 103, a second LE add-on 2000B is disposed along the span of the first edges 215A of two solar modules 103, a third LE add-on 2000C is disposed along the span of the first edges 215A of two solar modules 103; and a fourth LE add-on 2000D is disposed along the span of the first edge 215A of a single solar module 103. Additionally, in this example, the first and third LE add-ons 2000A, 2000C have the same width (and may or may not have the same profile), and the second and fourth LE add-ons 2000B, 2000D have the same width, but a smaller width than the first and third LE add-ons 2000A, 2000C (and may or may not have the same profile).

In some embodiments, an LE add-on may be used as a conduit for routing power cables, communication cables, fluidic cables, or other suitable elements. In various examples, such a configuration can provide a shelter from the elements for such cables and can avoid the need for other cable management systems (e.g., avoid the need for clips, conduit, or the like).

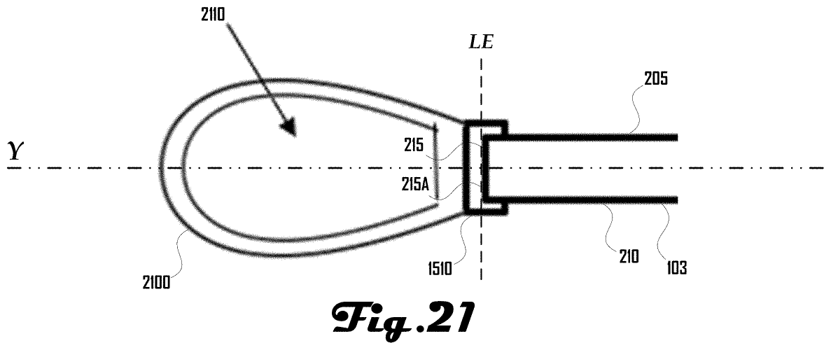

For example, FIG. 21 illustrates an embodiment of an LE add-on 2100 that comprises a cavity 2110 and a coupling bracket 1510 on an end of the LE add-on 2100 that allows the LE add-on to couple with a first edge 215A of a solar module 103. Such a cavity can be configured for routing of cables or other suitable elements as discussed herein, and in some examples, the cavity 2110 may or may not be pressurized or otherwise fillable with fluid and/or deflatable.

As discussed herein, the coupling bracket 1510 can comprise a web with a pair of arms extending from the web that defines a coupling cavity. The bracket 1510 can be disposed on the first edge 215A of the solar module 103 with the first edge 215A disposed within the coupling cavity with the face of the leading edge LE contacting the web with the pair of arms extending respectively over the top and bottom faces 205, 210 of the solar module 103.

In some embodiments, LE add-ons may be utilized solely on exterior rows of solar trackers 100 facing into the predominant wind direction for a solar site where the one or more solar trackers 100 are located, as these rows may incur the highest wind speeds and have no sheltering from the wind, unlike interior rows which in various examples are to some extent sheltered by upstream rows of solar trackers 100. However, the LE add-ons may also be used on interior rows of solar trackers 100 in various examples in order to make these rows of solar trackers 100 more resilient to the unsteady, misaligned flow emanating from the wake of upstream rows of solar trackers 100. In some embodiments, one or more external rows of solar trackers 100 can have LE add-ons that are configured differently than internal rows of solar trackers 100. Additionally, in some embodiments, LE add-ons of exterior solar trackers 100 or modules 103 of one or more rows of solar trackers 100 can be configured differently than internal solar trackers 100 or modules 103 of solar trackers. In various embodiments, having LE add-ons of different solar trackers 100 and/or solar modules 103 configured differently can be desirable to provide for different wind forces expected to be experienced at such different locations.

In some implementations, an LE add-on may be incorporated into the trailing edge (TE) of a solar module 103. This may be done in some examples in order to eliminate a sharp edge of the TE and alter the vortex formation emanating from the TE. This can also make the solar tracker 100 more robust to changes in wind direction in some examples. A TE add-on of various embodiments may be utilized in similar manners as described above for the LE add-on. In addition, the TE add-on in some examples may be utilized as an aerodynamic flap to bias module rotation in a given direction, and when modulated may be used to control stability of the tracker 100.

Manufacturing methods for an LE add-on can include various suitable methods, including extruded aluminum or plastic, rolled steel, composite layup, an extruded bladder, a seam welded bladder, and the like.

An LE add-on of some examples may be constructed of louvered panels or other segmented elements, which in some examples can reduce the projected area of the structure and limit the associated loading this produces.

Surface texturing methods may be employed on some embodiments of the LE add-on to strengthen the boundary layer through local mixing. This may be accomplished in various examples with surface roughness, texturing, dimpling or other suitable methods that promote turbulent mixing within the boundary layer for the purpose of strengthening the boundary layer through momentum addition or that provide other desirable characteristics.

Some embodiments can shape a portion or the entire solar module 103 with the contour of an airfoil. This can have the benefit in various examples of aerodynamically tailoring the full surface to manage the wind loading response.

The described embodiments are susceptible to various modifications and alternative forms, and specific examples thereof have been shown by way of example in the drawings and are herein described in detail. It should be understood, however, that the described embodiments are not to be limited to the particular forms or methods disclosed, but to the contrary, the present disclosure is to cover all modifications, equivalents, and alternatives. Additionally, elements of a given embodiment should not be construed to be applicable to only that example embodiment and therefore elements of one example embodiment can be applicable to other embodiments. Additionally, elements that are specifically shown in example embodiments should be construed to cover embodiments that comprise, consist essentially of, or consist of such elements, or such elements can be explicitly absent from further embodiments. Accordingly, the recitation of an element being present in one example should be construed to support some embodiments where such an element is explicitly absent.

What is claimed is:

1. A solar tracking system, the solar tracking system comprising:
a plurality of solar trackers disposed in a plurality of tracker rows at a location having a primary wind flow with a primary wind flow direction, with each of the solar trackers comprising:
a plurality of planar solar modules of the same size disposed adjacent to each other in a common plane and disposed in only a single row having at least 10 planar solar modules, the plurality of planar solar modules coupled together and configured to rotate together as a unit about no more than a single axis of rotation, the plurality of planar solar modules having respective planar top and bottom faces and respective opposing first and second edges disposed in respective common planes, the first edge being a leading edge and the second edge being a trailing edge where the leading edges of the plurality of planar solar modules are oriented into the primary wind flow such that the primary wind flow direction is from the leading edges of the plurality of planar solar modules to the trailing edges of the plurality of planar solar modules;
a plurality of fluidic actuators coupled to the plurality of planar solar modules along a common axis and configured to rotate the plurality of planar solar modules as a unit about the single axis of rotation, each of the fluidic actuators comprising:
a V-shaped bottom plate;
a planar top plate rotatably coupled to the V-shaped bottom plate, with the rotatable coupling configured for rotation about the single axis of rotation; and
a first and second inflatable bladder disposed between the V-shaped bottom plate and the planar top plate on opposing sides of the rotatable coupling, the first and second inflatable bladders configured to be inflated and deflated to cause the plurality of planar solar modules to rotate as the unit about the single axis of rotation; and
at least one leading edge add-on having an elongated body coupled to and extending from the leading edges of a plurality of the plurality of planar solar modules, the at least one leading edge add-on having an airfoil profile that provides aerodynamic benefits to the plurality of planar solar modules including a stronger boundary layer over a chord of the plurality of planar solar modules compared to the at least one leading edge add-on being absent, making the profile of the plurality of planar solar modules less prone to flow separation compared to the at least one leading edge add-on being absent, and increasing a stall angle, and softening a stall event of the plurality of planar solar modules compared to the at least one leading edge add-on being absent.

2. The solar tracking system of claim 1, wherein the at least one leading edge add-on is an after-market element that is coupled to one or more planar portions of one or more frames of the plurality of planar solar modules.

3. The solar tracking system of claim 1, wherein the at least one leading edge add-on is coupled only to the leading edges of the plurality of the plurality of planar solar modules, without contacting the planar top and bottom faces of the plurality of the plurality of planar solar modules.

4. The solar tracking system of claim 1, wherein the at least one leading edge add-on is coupled to the leading edges of the plurality of the plurality of planar solar modules and coupled to a portion of one or both of the planar top and bottom faces of the plurality of the plurality of planar solar modules.

5. A solar tracking system, the solar tracking system comprising:
one or more solar trackers disposed at a location having a primary wind flow with a primary wind flow direction, with each of the one or more solar trackers comprising:
a plurality of planar solar modules of the same size disposed adjacent to each other in a common plane and disposed in only a single row having at least 10 planar solar modules, the plurality of planar solar modules coupled together and configured to rotate together as a unit about no more than a single axis of rotation, the plurality of planar solar modules having respective planar top and bottom faces and respective opposing first and second edges disposed in respective common planes, the first edge being a leading edge and the second edge being a trailing edge where the leading edges of the plurality of planar solar modules are oriented into the primary wind flow such that the primary wind flow direction is from the leading edges of the plurality of planar solar modules to the trailing edges of the plurality of planar solar modules; and
at least one leading edge add-on having an elongated body coupled to and extending from the leading edges of a plurality of the plurality of planar solar modules, the at least one leading edge add-on having an airfoil profile that provides one or more aerodynamic benefits to the plurality of planar solar modules.

6. The solar tracking system of claim 5, wherein the one or more solar trackers further comprise:
one or more fluidic actuators coupled to the plurality of planar solar modules along a common axis and configured to rotate the plurality of planar solar modules as a unit about the single axis of rotation, each of the fluidic actuators comprising:
a V-shaped bottom plate;
a planar top plate rotatably coupled to the V-shaped bottom plate, with the rotatable coupling configured for rotation about the single axis of rotation; and a first and second inflatable bladder disposed between the V-shaped bottom plate and the planar top plate on opposing sides of the rotatable coupling, the first and second inflatable bladders configured to be inflated and deflated to cause the plurality of planar solar modules to rotate as the unit about the single axis of rotation.

7. The solar tracking system of claim 5, wherein the one or more aerodynamic benefits generated by the at least one leading edge add-on includes one or more of:
a stronger boundary layer over a chord of the plurality of planar solar modules compared to the at least one leading edge add-on being absent,
making the profile of the plurality of planar solar modules less prone to flow separation compared to the at least one leading edge add-on being absent, and increasing a stall angle, and
softening a stall event of the plurality of planar solar modules compared to the at least one leading edge add-on being absent.

8. The solar tracking system of claim 5, wherein the at least one leading edge add-on is an after-market element that is coupled to one or more planar portions of one or more frames of the plurality of planar solar modules.

9. The solar tracking system of claim 5, wherein the at least one leading edge add-on is coupled only to the leading edges of the plurality of the plurality of planar solar modules, without contacting the planar top and bottom faces of the plurality of the plurality of planar solar modules.

10. The solar tracking system of claim 5, wherein the at least one leading edge add-on is coupled to the leading edges of the plurality of the plurality of planar solar modules and coupled to a portion of one or both of the planar top and bottom faces of the plurality of the plurality of planar solar modules.

11. A solar tracking system, the solar tracking system comprising:
a plurality of solar modules disposed adjacent to each other in a common plane, the plurality of solar modules having respective top and bottom faces and respective opposing first and second edges, the first edges defining a leading edge and the second edges being a trailing edge where the leading edge of the plurality of solar modules is configured to be oriented into a primary air flow such that a primary air flow direction is from the leading edge of the plurality of solar modules to the trailing edge of the plurality of solar modules; and
at least one leading edge add-on having an elongated body coupled to and extending from the leading edge of a plurality of the plurality of solar modules, the at least one leading edge add-on having a profile that provides one or more aerodynamic benefits to the plurality of solar modules.

12. The solar tracking system of claim 11, wherein the plurality of solar modules are disposed in a single row having at least five solar modules, the plurality of solar modules coupled together and configured to rotate together as a unit about no more than a single axis of rotation.

13. The solar tracking system of claim 11, wherein the first edges of the plurality of solar modules are disposed in a common plane.

14. The solar tracking system of claim 11, wherein the at least one leading edge add-on has an airfoil profile.

15. The solar tracking system of claim 11, wherein the one or more aerodynamic benefits generated by the at least one leading edge add-on includes one or more of:
a stronger boundary layer over a chord of the plurality of solar modules compared to the at least one leading edge add-on being absent,
making the profile of the plurality of solar modules less prone to flow separation compared to the at least one leading edge add-on being absent, and increasing a stall angle, and
softening a stall event of the plurality of solar modules compared to the at least one leading edge add-on being absent.

16. The solar tracking system of claim 11, wherein the at least one leading edge add-on is an after-market element that is coupled to one or more frames of the plurality of solar modules.

17. The solar tracking system of claim 11, wherein the at least one leading edge add-on is coupled only to the leading edge of the plurality of the plurality of solar modules, without contacting the top and bottom faces of the plurality of the plurality of solar modules.

18. The solar tracking system of claim 11, wherein the at least one leading edge add-on is coupled to the leading edge of the plurality of the plurality of solar modules and coupled to a portion of one or both of the top and bottom faces of the plurality of the plurality of solar modules.

19. The solar tracking system of claim 11, wherein the at least one leading edge add-on is coupled to the leading edge via a coupling bracket of the at least one leading edge add-on, the coupling bracket comprising a web with a pair of arms extending from the web that defines a coupling cavity, the coupling bracket disposed on the leading edge with the leading edge disposed within the coupling cavity with the pair of arms extending respectively over the top and bottom faces of at last one of the plurality of solar modules.
